(19) United States
(12) Patent Application Publication
(10) Pub. No.: US 2013/0208990 A1
(43) Pub. Date: Aug. 15, 2013

(54) IMAGE COMPARISON DEVICE, IMAGE COMPARISON METHOD, IMAGE COMPARISON SYSTEM, SERVER, TERMINAL, TERMINAL CONTROL METHOD, AND TERMINAL CONTROL PROGRAM

(71) Applicants: Tatsuo Akiyama, Tokyo (JP); Shoji Yachida, Tokyo (JP)

(72) Inventors: Tatsuo Akiyama, Tokyo (JP); Shoji Yachida, Tokyo (JP)

(73) Assignee: NEC CORPORATION, Minato-ku, Tokyo (JP)

(21) Appl. No.: 13/880,281

(22) PCT Filed: Oct. 14, 2011
(86) PCT No.: PCT/JP2011/074238

§ 371 Date: Apr. 18, 2013

(30) Foreign Application Priority Data
Oct. 22, 2010 (JP) 2010-237463

(51) Int. Cl. G06K 9/62

(52) U.S. Cl. CPC G06K 9/6201
USPC 382/218

(57) ABSTRACT

[Problem] To provide an image comparison device which improves comparison precision and processing speed when deriving integrated comparison result on the basis of comparison results for individual local areas.

[Solution] An image comparison device comprises: image acquisition means for acquiring an image; image display means for displaying the image acquired by the image acquisition means; input location pattern acquisition means for acquiring an input location pattern representing a general location of an area which is a comparison object in an area of the image displayed by the image display means; comparison object general area estimation means for estimating, on the basis of the input location pattern, a comparison object general area which is a general area of the comparison object in the image displayed by the image display means; and comparison result presentation means for presenting a result of comparison between a search image and a registered image, at least one of which is an image in the comparison object general area.

### TECHNICAL FIELD

The present invention relates to an image comparison device which performs a comparison between a plurality of images, an image comparison method, an image comparison system, and a computer program.

### BACKGROUND ART

A general image comparison device compares a whole area of one image with a whole area of another image.

In contrast, in recent years, an image comparison device which compares a local area of one image with a local area of another image is proposed.

As such image comparison device, the image comparison device described below is known, in which an image for search (hereinafter, referred to as a search image), which is obtained by a method of photographing by a camera device or the like, is compared with an image which is registered in a database in advance (hereinafter, referred to as a registered image). First, this image comparison device estimates parameters of the geometric transformation for positioning. Next, the image comparison device performs a comparison of both of the images for each local area using the estimated parameters. The image comparison device derives an integrated comparison result on the basis of comparison results of each of the local areas (for example, refer to patent document 1).

Because the image comparison device described in the patent document 1 derives the integrated comparison result on the basis of the comparison result for each local area, the image comparison device has an advantage that the comparison between the images can be performed if the search image and the registered image have a certain extent of common area.

### PRIOR ART DOCUMENT

### Patent Document

[Patent document 1] WO2010/053109

### BRIEF SUMMARY OF THE INVENTION

### Problems to be Solved by the Invention

However, the image comparison device described in patent document 1 derives a local area as a comparison object in a whole image. Therefore, a local area is sometimes derived form a area which is not suitable for a comparison object and is used for comparison. Accordingly, the image comparison device described in patent document 1 has a problem in comparison accuracy and processing speed.

For example, assuming that the image comparison device described in patent document 1 compares the search image in which a guide plate and a vehicle A are photographed with the registered image in which the same guide plate as that in the search image and a vehicle B which is different from that in the search image are photographed. In this case, the image comparison device described in patent document 1 judges that a degree of consistency between the local area which includes the guide plate and is included the search image and the local area which includes the guide plate and is included in the registered image is high. However, the image comparison device described in patent document 1 may judge that a degree of consistency between the search image and the registered image is low as a whole because a degree of consistency between the local area which includes the vehicle A and is included in the search image and the local area which includes the vehicle B and is included in the registered image is low. Thus, even when a user does not want to perform the comparison between the area which includes the vehicle A and the area which includes the vehicle B, the image comparison device described in patent document 1 may derive a comparison result representing that a degree of consistency between the search image and the registered image is low. Further, because the image comparison device described in patent document 1 unnecessarily performs the comparison between the area which includes the vehicle A and the area which includes the vehicle B, which is unnecessary, the processing speed is lowered.

An object of the present invention is to solve the above-mentioned problem and provide an image comparison device in which comparison accuracy and processing speed when deriving an integrated comparison result on the basis of comparison results for individual local areas can be improved.

### Means to Solve the Problems

An image comparison device according to the invention comprises: image acquisition means for acquiring an image; image display means for displaying the image acquired by the image acquisition means; input location pattern acquisition means for acquiring an input location pattern representing a general location of an area which is a comparison object in an area of the image displayed by the image display means; comparison object general area estimation means for estimating, on the basis of the input location pattern, a comparison object general area which is a general area of the comparison object in the image displayed by the image display means; and comparison result presentation means for presenting a result of comparison between a search image and a registered image, at least one of which is an image in the comparison object general area.

An image comparison method according to the invention comprises: acquiring an image; displaying the acquired image on image display means; acquiring an input location pattern representing a general location of an area which is a comparison object in an area of the image displayed on the image display means; estimating, on the basis of the input location pattern, a comparison object general area which is a general area of the comparison object in the image displayed on the image display means; and presenting a comparison result between a search image and a registered image, at least one of which is an image in the comparison object general area.

A non-transitory computer-readable medium according to the invention stores an image comparison program which makes a computer function as: image acquisition means for acquiring an image, image display means for displaying the image acquired by the image acquisition means, input location pattern acquisition means for acquiring an input location pattern representing a general location of an area which is a comparison object in an area of the image displayed by the image display means, comparison object general area estimation means for estimating, on the basis of the input location pattern, a comparison object general area which is a general area of the comparison object in the image displayed by the image display means, and comparison result presentation means for presenting a comparison result between a search image and a registered image, at least one of which is the image in the comparison object general area.

### Effect of the Invention

The image comparison device of the present invention has an effect that comparison accuracy and processing speed when deriving an integrated comparison result on the basis of comparison results for individual local areas can be improved.

### BRIEF DESCRIPTION OF THE DRAWINGS

FIG. 1 is a hardware block diagram of an image comparison device according to a first exemplary embodiment of the present invention.

FIG. 2 is a functional block diagram of an image comparison device according to a first exemplary embodiment of the present invention.

FIG. 3 is a figure showing an example of a screen displayed in an image display unit according to a first exemplary embodiment of the present invention.

FIG. 4 is a flowchart explaining an image comparison operation of an image comparison device according to a first exemplary embodiment of the present invention.

FIG. 5 is a flowchart explaining a comparison object general area estimation operation of an image comparison device according to a first exemplary embodiment of the present invention.

FIG. 6 is a hardware block diagram of an image comparison device according to a second exemplary embodiment of the present invention.

FIG. 7 is a functional block diagram of an image comparison device according to a second exemplary embodiment of the present invention.

FIG. 8 is a flowchart explaining a registration operation of an image comparison device according to a second exemplary embodiment of the present invention.

FIG. 9 is a flowchart explaining a search operation of an image comparison device according to a second exemplary embodiment of the present invention.

FIG. 10 is a flowchart explaining a comparison object general area estimation operation of an image comparison device according to a second exemplary embodiment of the present invention.

FIG. 11 is a functional block diagram of an image comparison device according to third to tenth exemplary embodiments of the present invention.

FIG. 12 is a functional block diagram of an image comparison device according to an eleventh exemplary embodiment of the present invention.

FIG. 13 is a flowchart explaining a comparison object general area estimation operation of an image comparison device according to an eleventh exemplary embodiment of the present invention.

FIG. 14 is a functional block diagram of an image comparison device according to a twelfth exemplary embodiment of the present invention.

FIG. 15 is a figure showing an example of a screen displayed in an image display unit according to a twelfth exemplary embodiment of the present invention.

FIG. 16 is a flowchart explaining a comparison object general area estimation operation of an image comparison device according to a twelfth exemplary embodiment of the present invention.

FIG. 17 is a functional block diagram of an image comparison system according to a thirteenth exemplary embodiment of the present invention.

FIG. 18 is a flowchart explaining a comparison object general area estimation operation of an image comparison system according to a thirteenth exemplary embodiment of the present invention.

### EXEMPLARY EMBODIMENTS TO CARRY OUT THE INVENTION

Hereinafter, an exemplary embodiment of the present invention will be described in detail with reference to the drawing.

### First Exemplary Embodiment

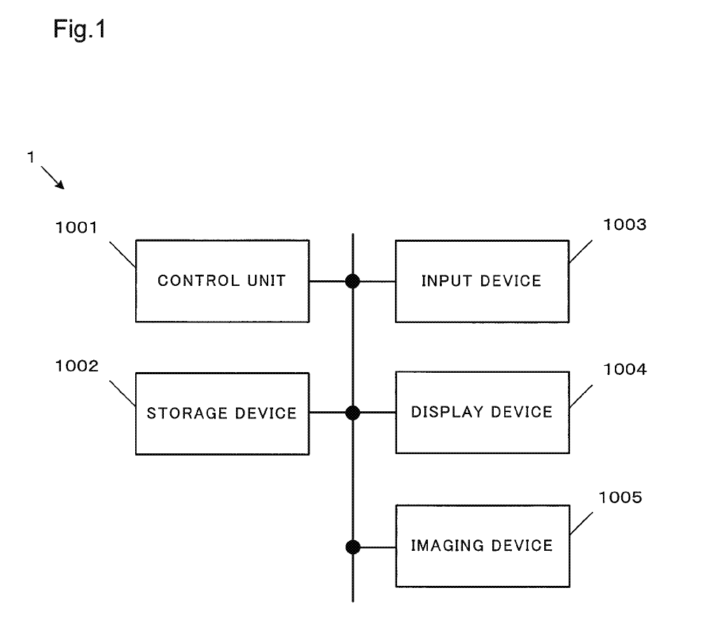

FIG. 1 is a hardware block diagram of an image comparison device 1 according to the first exemplary embodiment of the present invention.

In FIG. 1, the image comparison device 1 is composed of a computer device which includes a control unit 1001 including a CPU (Central Processing Unit), a RAM (Random Access Memory), and a ROM (Read Only Memory), a storage device 1002 such as a hard disk or the like, an input device 1003, a display device 1004, and an imaging device 1005 such as a camera, a scanner, or the like.

The control unit 1001 makes the computer device operate as the image comparison device 1 through reading out a computer program stored in the ROM or the storage device 1002, storing the computer program in the RAM, and executing the computer program, by the CPU.

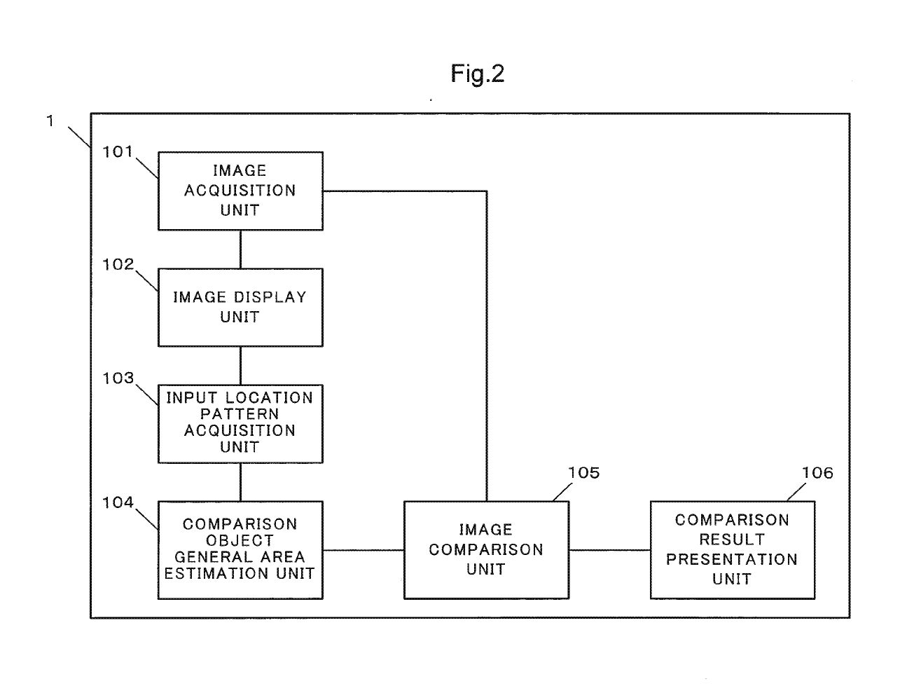

FIG. 2 is a functional block diagram of the image comparison device 1.

The image comparison device 1 includes an image acquisition unit 101, an image display unit 102, an input location pattern acquisition unit 103, a comparison object general area estimation unit 104, an image comparison unit 105, and a comparison result presentation unit 106.

The image acquisition unit 101 is composed using the control unit 1001, the storage device 1002, and the imaging device 1005. The image display unit 102 and the comparison result presentation unit 106 are composed using the control unit 1001 and the display device 1004. The input location pattern acquisition unit 103 is composed using the control unit 1001 and the input device 1003. The comparison object general area estimation unit 104 and the image comparison unit 105 are composed using the control unit 1001. The comparison result presentation unit 106 is composed using the control unit 1001 and the display device 1004. Further, the hardware configuration of each of the functional blocks of the image comparison device 1 is not limited to the above-mentioned configuration.

The image acquisition unit 101 acquires an image which is a comparison object. For example, the image acquisition unit 101 may acquire an image taken by the imaging device 1005. Further, the image acquisition unit 101 may acquire an image stored in the storage device 1002 or the RAM in advance.

Further, the image acquired by the image acquisition unit 101 may be a moving image and may be a still image.

The image display unit 102 displays the image acquired by the image acquisition unit 101. When the image acquired by the image acquisition unit 101 is a moving image, the image display unit 102 displays a still image at a certain time out of the moving image.

The input location pattern acquisition unit 103 acquires an input location pattern that is information representing a general location of the area which is the comparison object in the image displayed by the image display unit 102. The input location pattern acquisition unit 103 acquires information of a predetermined pattern that represents an input location as the input location pattern that is information representing the general location of the area which is the comparison object. The predetermined pattern of the information representing the input location is for example, a combination of the coordinates of two points. The input location pattern acquisition unit 103 may acquire the input location pattern that includes the combination of the coordinates of two points as information representing the general location of the area which is the comparison object.

For example, when the input device 1003 is composed including a mouse, the input location pattern acquisition unit 103 may acquire the information representing the locations of two points that are a start point and an end point of a mouse drag operation in the area of the image displayed by image display unit 102.

The comparison object general area estimation unit 104 estimates a comparison object general area representing the general area of the comparison object in the image displayed by the image display unit 102 on the basis of the input location pattern.

At that time, it is not necessary for the comparison object general area estimation unit 104 to estimate a correct area which the user desires to take as the comparison object is just included and it is enough for the comparison object general area estimation unit 104 to estimate the general area.

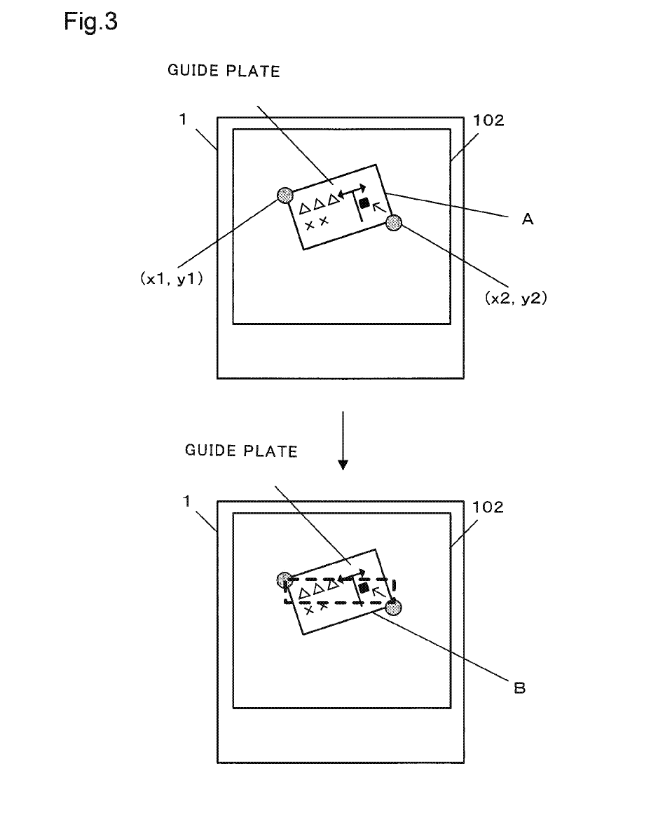

For example, as shown in FIG. 3, the comparison object general area estimation unit 104 may estimate that the area inside the rectangle whose diagonal is the line connecting the two points is the comparison object general area, on the basis of the input location pattern representing the coordinates of the two points. In the example of FIG. 3, the coordinates of the two points obtained as the input location pattern are (x1, y1) and (x2, y2), where x1≠x2 and y1≠y2. In the following description, minx is the smaller value of x1 and x2, maxx is the larger value of x1 and x2, miny is the smaller value of y1 and y2, and maxy is the larger value of y1 and y2. In this example, it is preferable that the comparison object general area estimation unit 104 estimates that the area inside the rectangle having four vertexes whose coordinates are (minx, miny), (maxx, miny), (maxx, maxy), and (minx, maxy) is the comparison object general area. The comparison object general area B shown in FIG. 3 is that rectangle.

The comparison object general area B, which is estimated by the comparison object general area estimation unit 104 on the basis of the coordinates of the two points, does not just include the area of a guide plate A, but includes the general area of the guide plate A. When it is assumed that the area which the user desires to take as the comparison object is the area including the guide plate A in the image shown in FIG. 3, the area estimated by the comparison object general area estimation unit 104 is not the correct area which just includes the area which the user desires to take as the comparison object, and is the general area.

The comparison object general area estimation unit 104 generates information representing an image in the comparison object general area from the estimated comparison object general area and the image acquired by the image acquisition unit 101. For example, the comparison object general area estimation unit 104 may cut out the comparison object general area from the image acquired by the image acquisition unit 101 and take the area which is cut out as information representing the image in the comparison object general area. Further, the comparison object general area estimation unit 104 may take a combination of the image acquired by the image acquisition unit 101 and the information representing the comparison object general area as the information representing the image in the comparison object general area. Further, the comparison object general area estimation unit 104 may generate a feature value (image feature value) of the image in the comparison object general area of the image acquired by the image acquisition unit 101 and take the feature value as the information representing the image in the comparison object general area.

The image comparison unit 105 acquires the information representing the image in the comparison object general area and take the information as the information representing at least one of the search image and the registered image that are compared with each other.

Namely, the image comparison unit 105 may acquire the information representing the image in the comparison object general area of a certain image and may take the acquired information as the information representing the search image. The image comparison unit 105 may acquire the information representing the image in the comparison object general area of another image and may take the acquired information as the information representing the registered image. Further, the image comparison unit 105 may acquire the information representing the image in the comparison object general area of a certain image and may take the acquired information as the information representing the search image. The image comparison unit 105 may acquire the information representing the whole area of the image acquired by the image acquisition unit 101 without change and may take the acquired information as the information representing the registered image. Further, the image comparison unit 105 may acquire the information representing the whole area of the image acquired by the image acquisition unit 101 without change and may take the acquired information as the information representing the search image. The image comparison unit 105 may acquire the information representing the image in the comparison object general area of a certain image and may take the acquired information as the information representing the registered image. The image comparison unit 105 may acquire the feature value of the image in the whole area of the image acquired by the image acquisition unit 101 or the feature value of the image in the comparison object general area and may take the acquired feature value as the information representing the search image and the registered image.

The image comparison unit 105 derives the integrated comparison result on the basis of the comparison results for the individual local areas in the search image and the registered image. Here, as technique to derive the integrated comparison result on the basis of the comparison results for the individual local areas, the image comparison unit 105 may use for example, the technique described in patent document 1. At that time, because the image comparison unit 105 derives the integrated comparison result on the basis of the comparison results for the individual local areas, it is not required that the area which the user desired to take as the comparison object is just included in the comparison object general area estimated by the comparison object general area estimation unit 104.

The comparison result presentation unit 106 presents the integrated comparison result between the search image and the registered image, which is derived by the image comparison unit 105. For example, the integrated comparison result may be an index based on the number of matches of local areas between the search image and the registered image.

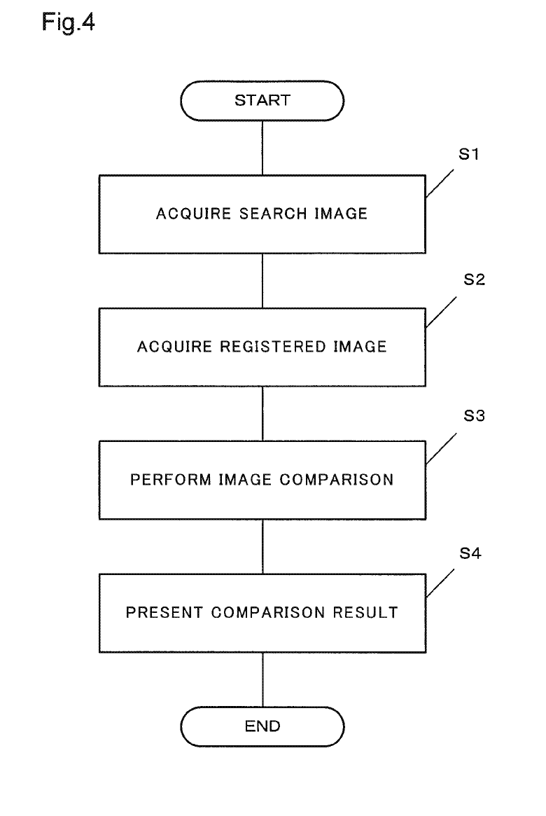

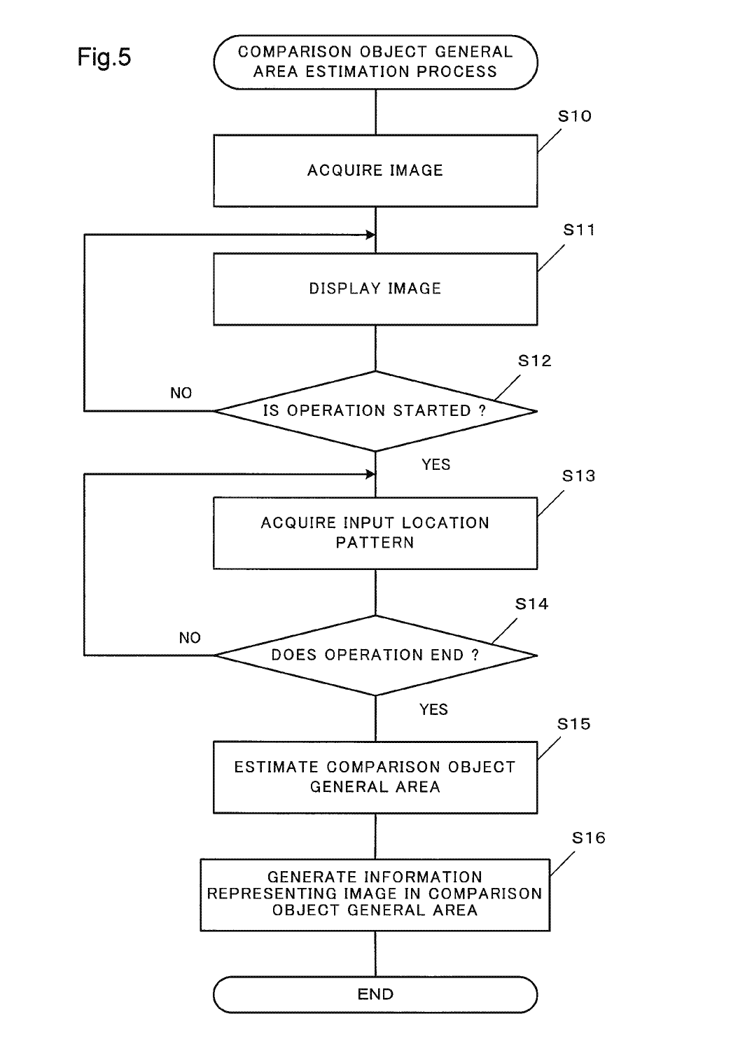

The operation of the image comparison device 1 having the above-mentioned configuration will be described with reference to FIG. 4 and FIG. 5.

First, the image acquisition unit 101 and the comparison object general area estimation unit 104 acquire the information representing the search image (step S1).

For example, the image comparison device 1 may acquire the information representing the whole area of the image acquired by the image acquisition unit 101 as the information representing the search image without change. The image comparison device 1 may acquire, as the information representing the search image, the information representing the image in the comparison object general area estimated by a comparison object general area estimation process described later.

Next, the image acquisition unit 101 and the comparison object general area estimation unit 104 acquire the information representing the registered image (step S2).

For example, the image comparison device 1 may acquire the information representing the whole area of the image acquired by the image acquisition unit 101 as the information representing the registered image without change. The image comparison device 1 may acquire, as the information representing the registered image, the information representing the image in the comparison object general area estimated by the comparison object general area estimation process described later.

However, in step S1, when the information representing the whole area of the image acquired by the image acquisition unit 101 is acquired as the information representing the search image without change, the image comparison device 1 acquires the information representing the image in the comparison object general area estimated by the comparison object general area estimation process described later as the information representing the registered image.

Next, the image comparison unit 105 derives the integrated comparison result of the search image and the registered image on the basis of comparison results for individual local areas (step S3). At that time, as described above, the image comparison unit 105 may use, for example, the technique described in patent document 1. Specifically, the image comparison unit 105 may derive the image feature values of each image from the search image or the registered image and may derive the integrated comparison result of the search image and the registered image on the basis of the derived image feature values. Further, when the image comparison unit 105 acquires the image feature values of each image as the information representing the search image or the registered image, the image comparison unit 105 may derive the integrated comparison result with respect to the search image and the registered image on the basis of the acquired image feature values.

Next, the comparison result presentation unit 106 presents the integrated comparison result in step S5 (step S4).

For example, the comparison result presentation unit 106 may present the index based on the number of matches of the local areas in each comparison object general area.

And, the operation of the image comparison device 1 ends.

Next, the comparison object general area estimation process performed in step S1 and step S2 will be described with reference to FIG. 5.

First, the image acquisition unit 101 acquires the image which is the comparison object (step S10).

Next, the image display unit 102 displays the image acquired by the image acquisition unit 101 (step S11).

Further, when the image which is acquired by the image acquisition unit 101 in step S10 is a moving image, the image display unit 102 displays a still image at a certain time out of the moving image. For example, when the image acquisition unit 101 continuously acquires the moving image, the image display unit 102 may display the image acquired by the image acquisition unit 101 at the time of execution of step S11. Further, when the image acquisition unit 101 acquires a sequence of still images of which the moving image is composed, the image display unit 102 may display a first still image that is a head of the sequence at the time of first execution of step S11. At the time of second or successive executions of step S11, the image display unit 102 may display the still image following the still image displayed last time.

Next, the input location pattern acquisition unit 103 determines whether or not a general location designation operation for designating the general location of the area which is the comparison object is started (step S12).

For example, when the input location pattern acquisition unit 103 detects a start of a mouse drag operation or the like in the image area of the image display unit 102, the input location pattern acquisition unit 103 may judge that the general location designation operation is started. Further, when the input location pattern acquisition unit 103 detects an input operation to an operation start button area displayed in the image display unit 102, the input location pattern acquisition unit 103 may judge that the general location designation operation is started.

In step S12, when the input location pattern acquisition unit 103 does not judge that the general location designation operation is started, the process of the image comparison device 1 returns to step S11.

On the other hand, in step S12, when the input location pattern acquisition unit 103 judges that the general location designation operation is started, the input location pattern acquisition unit 103 acquires the input location pattern (step S13).

For example, the input location pattern acquisition unit 103 may acquire a combination of the coordinates of a start point of the mouse drag operation and the coordinates of a mouse pointer at that time. The input location pattern acquisition unit 103 repeats the process of step S13 until it is judged that the general location designation operation ends (Yes in step S14).

In step S14, the input location pattern acquisition unit 103 determines whether or not the general location designation operation ends (step S 14).

For example, the input location pattern acquisition unit 103 may judge that the general location designation operation ends when the mouse drag operation ends. Further, the input location pattern acquisition unit 103 may judge the end of the general location designation operation on the basis of the input operation to an operation end button area displayed in the image display unit 102.

Next, the comparison object general area estimation unit 104 estimates the comparison object general area in this image on the basis of the input location pattern (step S15).

For example, when the input location pattern is composed of the coordinates indicating locations of two points, the comparison object general area estimation unit 104 may estimate that the area inside the rectangle whose diagonal is a line connecting the two points is the comparison object general area.

Next, the comparison object general area estimation unit 104 generates information representing the image in the comparison object general area of that image (step S16).

The comparison object general area estimation unit 104 may cut out the image data of the estimated comparison object general area, and may generate, as the information representing the image in the comparison object general area, a combination of that image and the information representing the comparison object general area. Further, the comparison object general area estimation unit 104 may generate the image feature values in the estimated comparison object general area as the information representing the image in the comparison object general area.

And, the comparison object general area estimation process performed by the image comparison device 1 ends.

Next, the effect of the first exemplary embodiment of the present invention will be described.

The comparison accuracy and the processing speed when deriving the integrated comparison result on the basis of the comparison results for the individual local areas can be improved by the image comparison device according to the first exemplary embodiment of the present invention.

The reason is that the comparison object general area estimation unit estimates the general area which is the comparison object, in the image which is the comparison object. Another reason is that the image comparison unit derives the integrated comparison result, on the basis of the comparison results for the individual local areas, using only the image in the comparison object general area as the object for the image to which the comparison object general area is estimated. Namely, it is not necessary for the image comparison unit to perform the comparison process to an area other than the comparison object general area. Therefore, the integrated comparison result is not affected by the comparison result of the local area included in the area other than the comparison object general area, and, as a result, the comparison accuracy can be improved. Further, it is not necessary to perform the comparison process to the area other than the comparison object general area. Therefore, the processing speed can be improved.

Further, when deriving the integrated comparison result using the comparison results for the individual local areas, the image comparison device according to the first exemplary embodiment of the present invention can reduce a user burden in designating, in the image which is the comparison object, the area which the user desires to take as the comparison object.

The reason is that the comparison object general area estimation unit estimates the comparison object general area on the basis of the operation for designating the general location of the area which is the comparison object, in the image which is the comparison object. For this reason, in the image comparison device according to the first exemplary embodiment of the present invention, it is not necessary for the user to accurately perform the area designation operation so that the area which the user desires to take as the comparison object is just included in the image which is the comparison object.

The effect of the reduction of such user's burden will be described in more detail.

First, as a technique related to the above-mentioned technique for estimating the comparison object general area, for example, an area designation technique described in Japanese Patent Application Laid-Open No. 2004-272835 will be described.

In the technique described in Japanese Patent Application Laid-Open No. 2004-272835, a display desired area designated by the user is detected on a display and contents to be displayed is displayed in the detected display desired area.

However, in the technique described in Japanese Patent Application Laid-Open No. 2004-272835, it is necessary to perform the area designation operation accurately so that the display desired area is just included. Therefore, this technique can not reduce the user burden in designating the area which the user desires to take as the comparison object unlike the first exemplary embodiment of the present invention.

Thus, in the image comparison device according to the first exemplary embodiment of the present invention, it is not necessary for the user to accurately perform the area designation operation so that the area, which the user desires to take as the comparison object in the image which is the comparison object, is just included. Accordingly, the image comparison device according to the first exemplary embodiment of the present invention can reduce the user burden in designating the area which the user desires to take as the comparison object. The image comparison device according to this exemplary embodiment has the above-mentioned effect in comparison with a case in which an area designation technique described in Japanese Patent Application Laid-Open No. 2004-272835 is applied to the technique to derive the integrated comparison result using the comparison results for the individual local areas.

### Second Exemplary Embodiment

Next, a second exemplary embodiment of the present invention will be described in detail with reference to the drawing. Further, in each drawing referred to in the description of this exemplary embodiment, the same reference numbers are used for the same components and the same operation steps as those of the first exemplary embodiment of the present invention and the detailed description will be omitted in this exemplary embodiment.

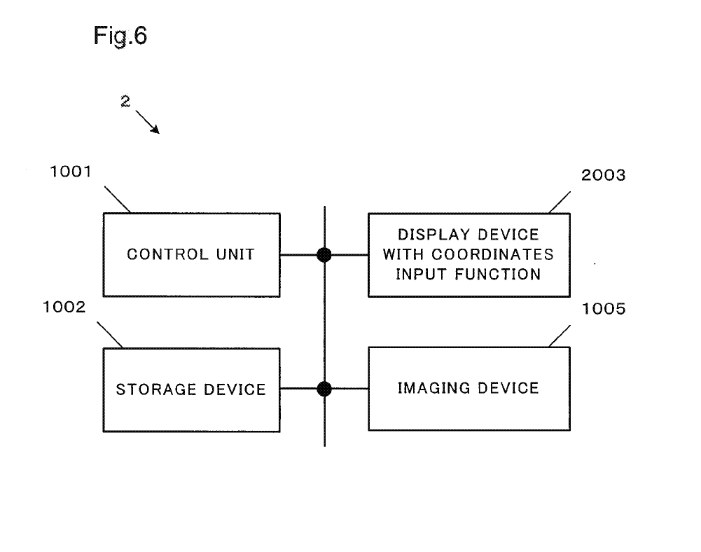

First, a hardware configuration of an image comparison device 2 according to the second exemplary embodiment of the present invention is shown in FIG. 6.

In FIG. 6, the image comparison device 2 is composed using a computer device, in comparison with the computer of the image comparison device 1 according to the first exemplary embodiment, which includes a display device with coordinates input function 2003 instead of the input device 1003 and the display device 1004.

The display device with coordinates input function 2003 is a display device having a function to get the coordinates of the contact location on the device by sensing the touch of a user's finger, a stylus, or the like. A touch panel display or the like is a typical device of the display device with coordinates input function 2003.

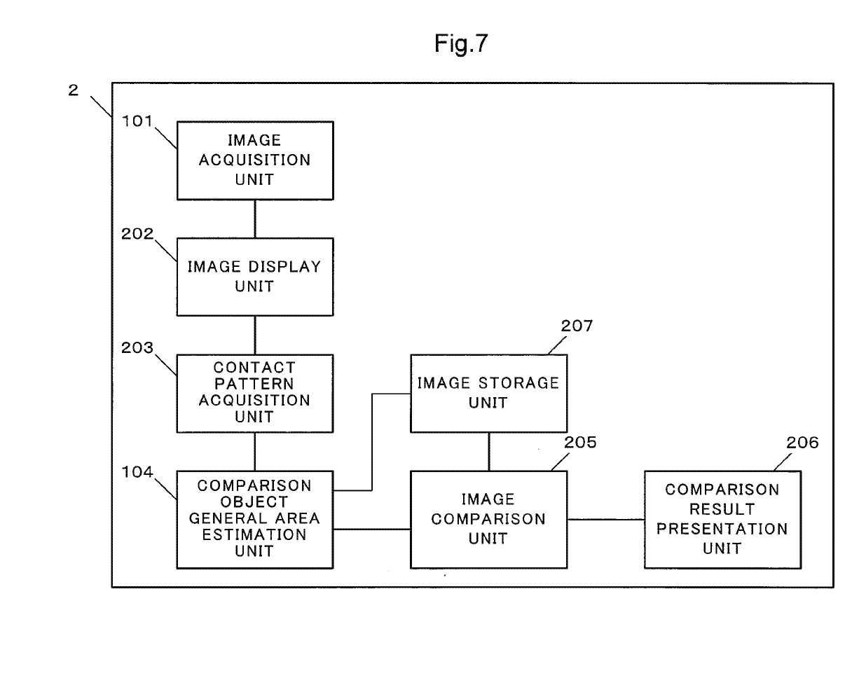

Next, a functional block configuration of the image comparison device 2 is shown in FIG. 7.

The image comparison device 2 is different from the image comparison device 1 according to the first exemplary embodiment of the present invention in that the image comparison device 2 includes an image display unit 202 instead of the image display unit 102, a contact pattern acquisition unit 203 instead of the input location pattern acquisition unit 103, an image comparison unit 205 instead of the image comparison unit 105, and a comparison result presentation unit 206 instead of the comparison result presentation unit 106, and further includes an image storage unit 207. Further, the contact pattern acquisition unit 203 is one of the exemplary embodiments of the input location pattern acquisition unit of the present invention.

The image display unit 202 and the contact pattern acquisition unit 203 are composed using the control unit 1001 and the display device 2003 with coordinates input function. The image storage unit 207 is composed using the control unit 1001 and the storage device 1002. Further, the hardware configuration of the functional block of the image comparison device 2 is not limited to the above-mentioned configuration.

The image display unit 202 displays the image acquired by the image acquisition unit 101 in the display device with coordinates input function 2003.

The contact pattern acquisition unit 203 has a function to detect a contact pattern to the display device with coordinates input function 2003. Typically, the contact pattern is a pattern of a combination of the contact locations where the user's finger, the stylus, or the like contacts with the display device with coordinates input function 2003.

Further, the contact pattern acquisition unit 203 acquires the contact pattern representing the general location of the area which is the comparison object. For example, the contact pattern representing the general location of the area which is the comparison object may be the contact pattern that includes the combination of the coordinates indicating two points that are almost simultaneously touched.

The image storage unit 207 stores the information representing the registered image.

Further, the image storage unit 207 may store the information representing the whole area of the image acquired by the image acquisition unit 101 as the information representing the registered image. Further, the image storage unit 207 may store the image in the comparison object general area that is cut out from the original image of the registered image. Further, the image storage unit 207 may store a combination of the original image of the registered image and the information representing the comparison object general area. Further, the image storage unit 207 may store the image feature values of the whole area of the image acquired by the image acquisition unit 101 or the image feature values in the comparison object general area as the information representing the registered image. Further, the image storage unit 207 may store not only the information acquired by the image acquisition unit 101 but also the information representing the registered image that is registered in advance.

Furthermore, the image storage unit 207 may store associate the related information about each registered image with being associated with each registered image. Here, the related information is such as a storage path, a URL (Uniform Resource Locator), or the like of the registered image. Further, the related information may include the image feature values related to the registered image.

The image comparison unit 205, which has a configuration that is similar to that of the image comparison unit 105 according to the first exemplary embodiment of the present invention, derives the integrated comparison result on the basis of comparison results for individual local areas of the search image and each registered image. Further, the image comparison unit 205 specifies the registered image corresponding to the search image among the registered images stored in the image storage unit 207, on the basis of these integrated comparison results. For example, the image comparison unit 205 may specify the registered image of which a degree of consistency with the search image is equal to or greater than a threshold value.

However, because there is a case in which the registered image corresponding to the search image is not registered, the image comparison unit 205 does not necessarily have to specify a corresponding registered image for each of the search images. For example, when the image comparison result shows that there is no registered image of which a degree of consistency with the search image is equal to or greater than the threshold value, the image comparison unit 205 does not have to specify the registered image.

Further, the image comparison unit 205 may have a function to derive the feature values of each of the registered image and the search image and to derive the comparison results for the individual local areas using the derived feature values. At that time, the image comparison unit 205 may use the technique described in patent document 1.

The comparison result presentation unit 206 presents the information representing the registered image that is specified by the image comparison unit 205. When there is the related information associated with the specified registered image, the comparison result presentation unit 206 may acquire the related information from the image storage unit 207 and may present the acquired related information.

The operation of the image comparison device 2 having the above-mentioned configuration will be described with reference to the drawing.

Here, a registration process in which the image comparison device 2 registers the registered image in advance, a search process in which the registered image corresponding to the search image is specified, and a comparison object general area estimation process when the registered image or the search image is acquired will be described.

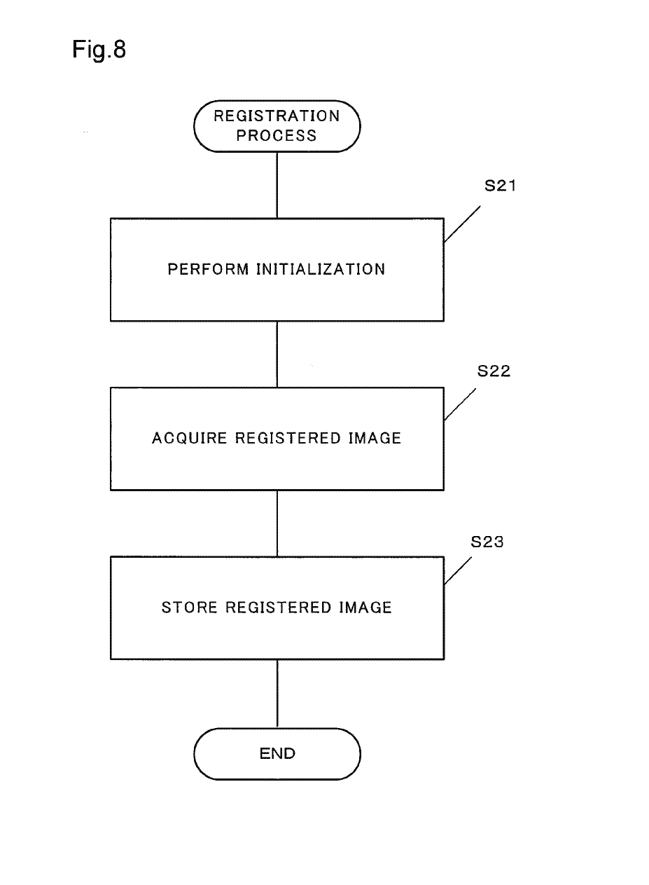

First, the registration process of the image comparison device 2 will be described by using FIG. 8.

First, the image comparison device 2 performs an initialization process (step S21). Specifically, for example, the image comparison device 2 controls the contact pattern acquisition unit 203 so that the contact pattern acquisition unit 203 can accept the touch operation via the display device with coordinates input function 2003.

Next, the image acquisition unit 101 and the comparison object general area estimation unit 104 acquire the information representing the registered image (step S22).

At that time, the image acquisition unit 101 may additionally acquire the storage path, the URL, or the like as the related information related to the registered image.

Further, the image comparison device 2 may acquire the information representing the whole area of the image acquired by the image acquisition unit 101 as the information representing the registered image, without change. Further, the image comparison device 2 may acquire, as the information representing the registered image, the information representing the image in the comparison object general area that is estimated by the comparison object general area estimation process described later. Further, the image comparison device 2 may acquire, as the information representing the registered image, the image feature values of the whole area of the image acquired by the image acquisition unit 101 or the image feature values that is the information representing the image in the comparison object general area that is estimated by the comparison object general area estimation process described later.

Next, the image storage unit 207 stores the information representing the registered image that is acquired in step S22 (step S23).

At that time, when the image storage unit 207 has acquired the related information in step S22, the image storage unit 207 may associate the related information with the information representing the registered image and store them.

Further, the image storage unit 207 may derive the feature values of the registered image by using the image comparison unit 205 and store the derived feature values as the related information.

Further, the image storage unit 207 may perform an operation to assign an identification number for uniquely identifying the registered image and may store the assigned identification number as the related information.

And, the registration process performed by the image comparison device 2 ends.

Further, as mentioned above, the image storage unit 207 may store another registered image beforehand in addition to the registered image registered by this registration process.

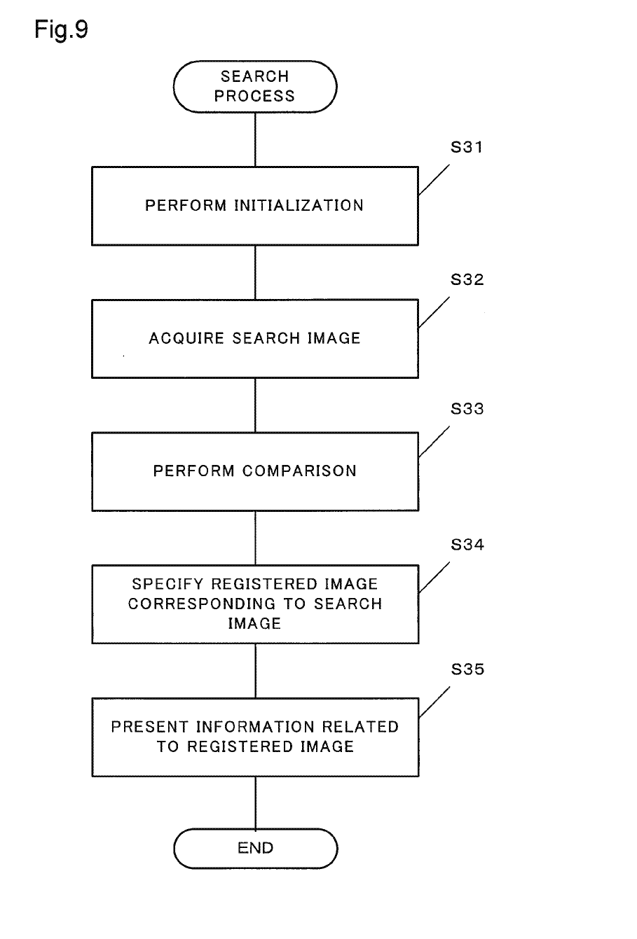

Next, a search process performed by the image comparison device 2 will be described using FIG. 9.

Here, first, the image comparison device 2 performs the initialization process (step S31). For example, the image comparison device 2 controls the contact pattern acquisition unit 203 so that the contact pattern acquisition unit 203 can accept the touch operation via the display device with coordinates input function 2003 can sense the touch operation.

Next, the image acquisition unit 101 and the comparison object general area estimation unit 104 acquire the information representing the search image (step S32).

Further, the image comparison device 2 may acquire, as the information representing the search image, the information representing the whole area of the image acquired by the image acquisition unit 101 without change. The image comparison device 2 may acquire, as the information representing the search image, the information representing the image in the comparison object general area that is estimated by the comparison object general area estimation process described later. Further, the image comparison device 2 may acquire, as the information representing the search image, the image feature values of the whole area of the image acquired by the image acquisition unit 101, or the image feature values that is the information representing the image in the comparison object general area that is estimated by the comparison object general area estimation process described later.

However, when the image comparison device 2 has acquired, as the information representing the registered image without change, the information representing the whole area of the image acquired by the image acquisition unit 101, the image comparison device 2 acquires, as the information representing the search image, the information representing the image in the comparison object general area that is estimated by the comparison object general area estimation process described later.

Next, the image comparison unit 205 derives the integrated comparison result on the basis of comparison results for individual local areas of the search image and each registered image which is stored in the image storage unit 207 (step S33).

At that time, the image comparison unit 205 may derive the image feature values of each image from the search image and the registered image and may derive the integrated comparison result of the search image and the registered image using the derived image feature values. Further, the image comparison unit 205 may perform the comparison using the feature values included in the related information of the registered image. Further, when the image feature values is stored in the image storage unit 207 as the information representing the registered image, the image comparison unit 205 may perform the comparison using the stored image feature values. When the image comparison unit 205 has acquired the image feature values as the information representing the search image in step S32, the image comparison unit 205 may perform the comparison using the acquired image feature value.

Next, the image comparison unit 205 specifies the registered image which is corresponding to the search image on the basis of the comparison result between the search image in step S33 and the each registered image (step S34).

Next, the comparison result presentation unit 206 acquires the related information of the registered image specified in step S34. The comparison result presentation unit 206 presents the acquired related information together with the information representing the registered image specified in step S34 (step S35).

At that time, the comparison result presentation unit 206 may present the area corresponding to the specified registered image superimposing the presented area on the area of the search image or the original image of the search image with a high degree of consistency with the registered image. And, in this case, the comparison result presentation unit 206 may further present the related information superimposing the related information on or near the corresponding area of the registered image which is superimposed on the search image.

Further, the comparison result presentation unit 206 may present the storage path and the URL that are the related information as the information representing the specified registered image.

Further, when the registered image corresponding to the search image is not specified in step S34, the comparison result presentation unit 206 may present predetermined information representing “No corresponding registered image exist”.

Next, the comparison object general area estimation process of step S22 and step S32 will be described.

First, the image acquisition unit 101 acquires the image which is the comparison object (step S40).

Next, the image display unit 202 displays the image acquired by the image acquisition unit 101 (step S41).

Further, when the acquired image is a moving image, the image display unit 102 displays the image at a certain time in the moving image. For example, when the image acquisition unit 10 acquires the moving image continuously, the image display unit 202 may display the still image acquired by the image acquisition unit 101 at the time of execution of step S41. Further, when the image acquisition unit 101 has already acquired a sequence of still images of which the moving image is composed, the image display unit 102 may display a first still image that is a head of the sequence at the time of first execution of step S41 and may display the next still image of the still image displayed last time at the time of second or successive executions of step S41.

Next, the contact pattern acquisition unit 203 determines whether or not the general location designation operation to designate the general location of the area which is the comparison object is started (step S42).

For example, when the contact pattern acquisition unit 203 detects the contact with the area of the image displayed by the image display unit 202, the contact pattern acquisition unit 203 may judge that the general location designation operation is started. Further, when the contact pattern acquisition unit 203 detects the predetermined contact pattern representing the start of the general location designation operation, the contact pattern acquisition unit 203 may judge that the general location designation operation is started.

In step S42, when the contact pattern acquisition unit 203 does not judge that the general location designation operation is started, the image comparison device 2 performs a process of step S41 once again.

On the other hand, in step S42, when the contact pattern acquisition unit 203 judges that the general location designation operation is started, the contact pattern acquisition unit 203 acquires the contact pattern (step S43).

The contact pattern acquisition unit 203 may hold a history of the information representing a contact location on the screen of the display device with coordinates input function 2003 and may acquire the contact pattern from the history. Further, when the contact pattern acquisition unit 203 judges using the contact pattern representing the start of the general location designation operation in step S42, the contact pattern acquisition unit 203 does not have to hold the information representing the contact location included in the contact pattern representing the start of the general location designation operation as the history.

The contact pattern acquisition unit 203 repeats the process of step S43 until it judges that the general location designation operation ends (Yes in step S44).

In step S44, the contact pattern acquisition unit 203 determines whether or not the general location designation operation ends (step S44).

For example, when the contact pattern acquisition unit 203 can judge that the contact pattern required for estimating the comparison object general area using the history of the contact locations that is held is acquired, the contact pattern acquisition unit 203 may judge that the general location designation operation ends. Further, when the contact pattern acquisition unit 203 detects the contact with an end button area displayed by the image display unit 202, the contact pattern acquisition unit 203 may judge that the general location designation operation ends.

Next, the comparison object general area estimation unit 104 estimates the comparison object general area in that image on the basis of the acquired contact pattern (step S45).

For example, when the contact pattern includes the coordinates of two points, the comparison object general area estimation unit 104 may estimate that the area inside the rectangle whose diagonal is the line connecting the two points is the comparison object general area.

Next, the comparison object general area estimation unit 104 generates the information representing the image in the comparison object general area of that image (step S16).

At that time, as the information representing the image in the comparison object general area, the comparison object general area estimation unit 104 may cut out the image data of the estimated comparison object general area, and may generate a combination of that image and the information representing the comparison object general area. Further, the comparison object general area estimation unit 104 may generate the image feature values of the image in the estimated comparison object general area as the information representing the image in the comparison object general area.

And, the comparison object general area estimation process performed by the image comparison device 2 ends.

Next, the effect of the second exemplary embodiment of the present invention will be described.

The search precision and the search processing speed when searching for the registered image corresponding to the search image using a technique to derive the integrated comparison result from the comparison results for the individual local areas can be improved by the image comparison device according to the second exemplary embodiment of the present invention.

The reason is that the comparison object general area estimation unit estimates the general area which is the comparison object in the acquired image, and the image comparison unit uses the image in the estimated comparison object general area as the search image and specifies the corresponding registered image. Further, the reason is that the image storage unit stores, as the registered image, the image in the comparison object general area estimated by the comparison object general area estimation unit, and the image comparison unit searches for the registered image corresponding to the search image.

Namely, the reason is that in the image comparison device according to the second exemplary embodiment of the present invention, because the area that is not the comparison object is not included in the search image which is compared by the image comparison unit and the registered image, the image comparison device does not perform the unnecessary comparison process and this contributes the improvement of the search processing speed. Further, the reason is that in the image comparison device according to the second exemplary embodiment of the present invention, because the accuracy of the comparison between the search image and each registered image is improved, as a result, the precision of the search by which the registered image corresponding to the search image is specified can be improved.

The image comparison device according to the second exemplary embodiment of the present invention can further reduce a user burden in designating the area which the user desires to take as the comparison object in the image which is the comparison object when searching for the registered image corresponding to the search image using the technique to derive the integrated comparison result from the comparison results for the individual local areas.

The reason is that the comparison object general area estimation unit estimates the comparison object general area on the basis of a simple contact pattern. Therefore, in the image comparison device according to the second exemplary embodiment of the present invention, it is not necessary for the user to perform the accurate touch operation so that the area which the user desires to take as the comparison object is enclosed.

The effect of the reduction in user burden will be described in more detail.

First, as a technique related to the above-mentioned technique to estimate the comparison object general area on the basis of the contact pattern, the area designation technique described in, for example, Japanese Patent Application Laid-Open No. 2009-282634 will be described.

The technique described in Japanese Patent Application Laid-Open No. 2009-282634 a plurality of touch input locations is detected simultaneously and a circular designation area is specified on the basis of a combination of the touch input locations that are detected simultaneously. In the technique described in Japanese Patent Application Laid-Open No. 2009-282634, an object whose display area is included in the specified circular designation area at a predetermined rate is selected.

However, in the technique described in Japanese Patent Application Laid-Open No. 2009-282634, the object whose display area is included in the circular designation area at a rate that is equal to or greater than the predetermined rate is selected. Consequently, it is necessary to perform the touch input operation so that the object which is the comparison object is included in the circular designation area at a rate that is equal to or greater than the predetermined rate. Accordingly, by the technique described in Japanese Patent Application Laid-Open No. 2009-282634, the user burden in selecting the object cannot be reduced.

Thus, in the image comparison device according to the second exemplary embodiment of the present invention, it is not necessary for the user to perform the touch operation in which the area which the user desires to take as the comparison object is included in the circular designation area in the image which is the comparison object. Accordingly, the image comparison device according to the second exemplary embodiment of the present invention can further reduce the user burden in designating the area which the user desires to take as the comparison object. The image comparison device of the second exemplary embodiment of the present invention has the above-mentioned effect in comparison with a case in which the area designation technique described in Japanese Patent Application Laid-Open No. 2009-282634 is applied to the technique to derive the integrated comparison result using the comparison results for the individual local areas.

Further, in the second exemplary embodiment of the present invention, when the image feature values derived from the registered image included in the related information is stored in the image storage unit 207, the storage of the registered image itself can be omitted. That is because the image comparison unit 205 can derive the integrated comparison result based on comparison results for individual local areas, using the image feature value.

Additionally, in the second exemplary embodiment or other exemplary embodiments of the present invention, position information representing a place or direction information representing a direction can be stored in the image storage unit 207, included in the related information related to each registered image. Further, the position information representing a place may be information measured by a positioning system. The GPS (Global Positioning System) is a typical positioning system. Further, the direction information may be information acquired by an electronic compass or the like.

In this case, the image acquisition unit 101 may acquire the position information or the direction information together with the search image. The image comparison unit 205 may specify the registered image corresponding to the search image using only the registered image having the position information or the direction information that is similar to the position information or the direction information that is acquired together with the search image as the comparison object.

For example, when the position information acquired together with the search image represents a place Q and the position information associated with the registered image represents a place R, the image comparison unit 205 may use, as the comparison object, the registered image associated with the place R located within a predetermined distance from the place Q.

Further, for example, the image comparison unit 205 may use, as the comparison object, the registered image associated with the direction information representing the direction whose difference from the direction represented by the direction information acquired together with the search image is smaller than a predetermined value.

The image comparison device having the above-mentioned configuration according to the second exemplary embodiment or other exemplary embodiments of the present invention can reduce the number of the registered images which is the comparison object and this further contributes to a higher search processing speed.

Further, in the second exemplary embodiment of the present invention, the related information in various languages, which is related to the registered image, is stored the image storage unit 207. And, the comparison result presentation unit 206 may display the information representing the registered image corresponding to the search image in a language according to a user attribute which is set in advance or a selection operation.

### Third Exemplary Embodiment

Next, a third exemplary embodiment of the present invention will be described in detail with reference to the drawing. Further, in each drawing referred to in the description of this exemplary embodiment, the same reference numbers are used for the same components and the same operation steps as those of the second exemplary embodiment of the present invention, and the detailed description will be omitted in this exemplary embodiment.

First, an image comparison device 3 according to the third exemplary embodiment of the present invention is composed using a computer device of the image comparison device 2 according to the second exemplary embodiment of the present invention shown in FIG. 6.

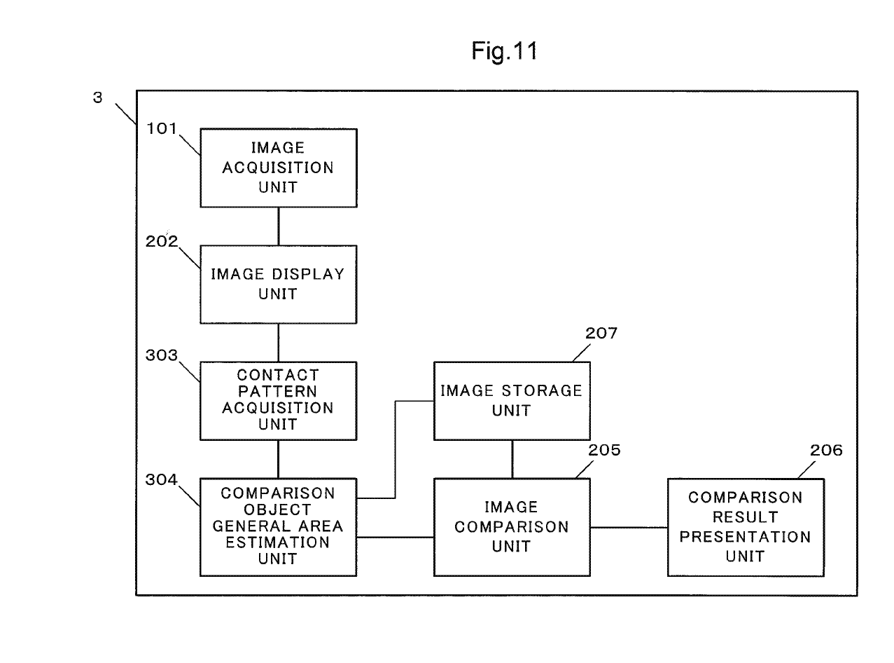

Next, a functional block diagram of the image comparison device 3 is shown in FIG. 11.

The difference between the image comparison device 3 and the image comparison device 2 according to the second exemplary embodiment of the present invention is that the image comparison device 3 includes a contact pattern acquisition unit 303 instead of the contact pattern acquisition unit 203, and a comparison object general area estimation unit 304 instead of the comparison object general area estimation unit 104.

The contact pattern acquisition unit 303 has a configuration which is similar to that of the contact pattern acquisition unit 203 according to the second exemplary embodiment of the present invention. However, the contact pattern acquisition unit 303 is different from the contact pattern acquisition unit 203 in acquiring the contact pattern including coordinates representing one point as the contact pattern representing the general location of the area which is the comparison object.

The comparison object general area estimation unit 304 estimates that an area inside a rectangle whose four vertexes are located at positions which have respectively predetermined distances from the one point which is the contact pattern is the comparison object general area.

For example, when the coordinates of the one point which is the contact pattern is (x1, y1), the comparison object general area estimation unit 304 estimates that the rectangle having four vertexes whose coordinates are (x1+dx1L, y1+dy1L), (x1+dx1R, y1+dy1L), (x1+dx1R, y1+dy1R), and (x1+dx1L, y1+dy1R) is the comparison object general area.

The operation of the image comparison device 3 having the above-mentioned configuration will be described.

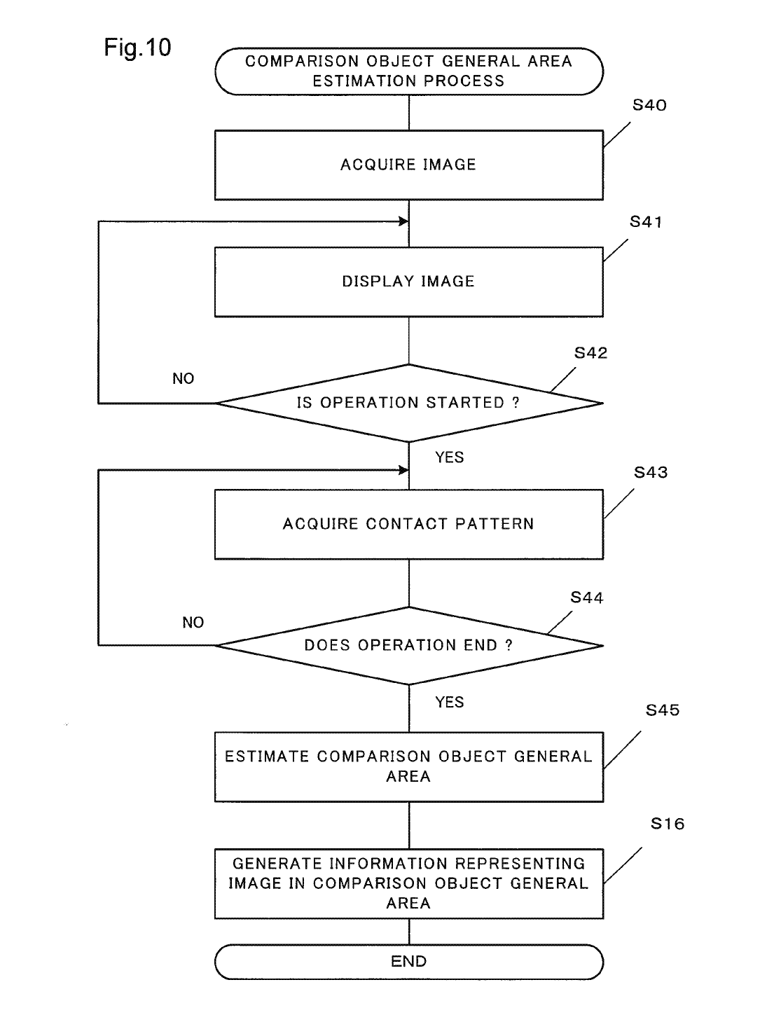

The operation of the image comparison device 3 is different from that of the image comparison device 2 according to the second exemplary embodiment of the present invention in the operation of steps S43 to S45, shown in FIG. 10, in the comparison object general area estimation processes.

In step S43, the contact pattern acquisition unit 303 repeats a process for acquiring the contact pattern including the coordinates of the one point until it can be judged that the general position designation operation ends (Yes in step S44). Further, in step S44, like the second exemplary embodiment of the present invention, if the contact pattern acquisition unit 203 can judge that the coordinates of the one point is acquired referring to the history of the contact locations, the contact pattern acquisition unit 203 may judge that the general location designation operation ends. Further, the contact pattern acquisition unit 203 may judge that the general location designation operation ends by detecting a contact with the end button area.

In step S45, the comparison object general area estimation unit 304 estimates that the area inside the rectangle whose four vertexes are located at positions which have respectively predetermined distances from the one point whose coordinates are acquired as the contact pattern is the comparison object general area in this image.

After this operation, the image comparison device 3 performs the same operation as the operation of the image comparison device 2 according to the second exemplary embodiment of the present invention, and generates the information representing the image in the comparison object general area of the image.

Now, the description of the comparison object general area estimation process of the image comparison device 3 ended.

Next, the effect of the image comparison device according to the third exemplary embodiment of the present invention will be described.

The image comparison device according to the third exemplary embodiment of the present invention can reduce a user burden in designating the comparison object general area in the image which is the comparison object in the case of searching for the registered image corresponding to the search image using the technique to derive the integrated comparison result from the comparison results for the individual local areas.

The reason is that the comparison object general area estimation unit estimates the comparison object general area on the basis of a simple contact pattern which is the coordinates of one point. Consequently, in the image comparison device according to the third exemplary embodiment of the present invention, it is not necessary for the user to perform the touch operation accurately designating the area which the user desires to take as the comparison object.

### Fourth Exemplary Embodiment

Next, a fourth exemplary embodiment of the present invention will be described.

The image comparison device according to the fourth exemplary embodiment of the present invention has a configuration which is similar to that of the image comparison device 3 according to the third exemplary embodiment of the present invention. However, the configurations of the contact pattern acquisition unit 303 and the comparison object general area estimation unit 304 are different from those of the image comparison device 3 according to the third exemplary embodiment.

The contact pattern acquisition unit 303 according to this exemplary embodiment acquires the contact pattern including the coordinates of three points as the contact pattern representing the general location of the area which is the comparison object. In this case, it is preferable that the contact pattern acquisition unit 303 according to this exemplary embodiment stores the order of the acquisition of the coordinates of three points.

Further, the comparison object general area estimation unit 304 according to this exemplary embodiment estimates that an area inside a parallelogram whose vertexes include the three points of the contact pattern is the comparison object general area. For example, when three points P1, P2, and P3 are acquired in this order, the comparison object general area estimation unit 304 according to this exemplary embodiment may estimate that the area inside the parallelogram whose two sides are the line connecting the points P1 and P2 and the line connecting the points P2 and P3 is the comparison object general area.

Further, when the contact pattern acquisition unit 303 does not acquire information on the order of acquisition of the points P1, P2, and P3, the comparison object general area estimation unit 304 according to this exemplary embodiment may estimate the comparison object general area by arbitrarily determining the order of the acquisition of the three points. Further, even when the information on the order of the acquisition of the three points P1, P2, and P3 of the contact pattern is acquired, the comparison object general area estimation unit 304 according to this exemplary embodiment may estimate that a parallelogram, other than the above-mentioned parallelogram, whose vertexes include the three points P1, P2, and P3 is the comparison object general area.

The operation of image comparison device having the above-mentioned configuration according to the fourth exemplary embodiment of the present invention is different in the operation in steps S43 to S45, in comparison with the comparison object general area estimation process of the image comparison device 3 according to the third exemplary embodiment of the present invention. The image comparison device according to the fourth exemplary embodiment of the present invention acquires the contact pattern including the coordinates of three points and estimates that the parallelogram whose vertexes include the three points specified by the coordinates is the comparison object general area.

Next, the effect of the image comparison device according to the fourth exemplary embodiment of the present invention will be described.

Such image comparison device according to the fourth exemplary embodiment of the present invention estimates the comparison object general area on the basis of a simple contact pattern including the coordinates of three points. Therefore, the image comparison device according to the fourth exemplary embodiment can reduce the user burden in designating the area which the user desires to take as the comparison object.

Further, the comparison object general area estimation unit 304 according to this exemplary embodiment may estimate that an area inside a circumscribed rectangle of the parallelogram whose vertexes include the three points which are the contact pattern is the comparison object general area.

For example, the comparison object general area estimation unit 304 may derive minx which is the minimum x-coordinate value, maxx which is the maximum x-coordinate value, miny which is the minimum y-coordinate value, and maxy which is the maximum y-coordinate value from the coordinates of the above-mentioned three points P1, P2, and P3 and the coordinates of the remaining vertex P4 of the parallelogram whose vertexes include P1, P2, and P3. Here, the coordinates of the point P4 is (x4, y4). Next, the comparison object general area estimation unit 304 may estimate that the area inside the rectangle having four vertexes whose coordinates are (minx, miny), (maxx, miny), (maxx, maxy), and (minx, maxy) is the comparison object general area.

As a result, the image comparison device according to this exemplary embodiment can estimate, as the comparison object general area, a wider area than the area of the parallelogram whose vertexes include the three points. Accordingly, the image comparison device according to this exemplary embodiment can ensure high comparison accuracy even when there is small inconsistency between the area which the user desires to take as the comparison object and the area designated by the actual touch operation.

### Fifth Exemplary Embodiment

Next, a fifth exemplary embodiment of the present invention will be described.

The image comparison device according to the fifth exemplary embodiment of the present invention has a configuration that is similar to that of the image comparison device 3 according to the third exemplary embodiment of the present invention. However, the configurations of the contact pattern acquisition unit 303 and the comparison object general area estimation unit 304 of the image comparison device according to the fifth exemplary embodiment are different from those of the image comparison device 3 according to the third exemplary embodiment.

The contact pattern acquisition unit 303 according to this exemplary embodiment acquires the contact pattern including the coordinates representing n points (where n is an integer of three or more) as the contact pattern representing the general location of the area which is the comparison object.

The comparison object general area estimation unit 304 according to this exemplary embodiment estimates that the area inside the polygon whose n vertexes are the n points of the contact pattern is the comparison object general area.

The operation of the image comparison device having the above-mentioned configuration according to the fifth exemplary embodiment of the present invention is different in the operation in steps S43 to S45, in comparison with the comparison object general area estimation process of the image comparison device 3 according to the third exemplary embodiment of the present invention. The image comparison device according to the fifth exemplary embodiment of the present invention acquires the contact pattern including the coordinates of n points and estimates that the polygon whose n vertexes are the n points is the comparison object general area.

Next, the effect of the image comparison device according to the fifth exemplary embodiment of the present invention will be described.

Such image comparison device according to the fifth exemplary embodiment of the present invention estimates the comparison object general area on the basis of a simple contact pattern including the coordinates of the n points. Therefore, the image comparison device according to the fifth exemplary embodiment can reduce the user burden in designating the area which the user desires to take as the comparison object.

### Sixth Exemplary Embodiment

Next, a sixth exemplary embodiment of the present invention will be described.

The image comparison device according to the sixth exemplary embodiment of the present invention has a configuration that is similar to that of the image comparison device 3 according to the third exemplary embodiment of the present invention. However, the configurations of the contact pattern acquisition unit 303 and the comparison object general area estimation unit 304 of the image comparison device according to the sixth exemplary embodiment are different from those of the image comparison device 3 according to the third exemplary embodiment.

The contact pattern acquisition unit 303 according to this exemplary embodiment acquires the contact pattern including the coordinates of n points (where n is an integer of three or more) as the contact pattern representing the general location of the area which is the comparison object. Further, the contact pattern including the coordinates representing the n points includes the contact pattern which is composed of various lines. The contact pattern which is composed of various lines is considered to be composed of a plurality of spatially continuous points regardless of the type of line, such as a curved line or straight line, an open curve or a closed curve, or the like.

The comparison object general area estimation unit 304 according to this exemplary embodiment estimates that an area inside a circumscribed rectangle of the polygon whose n vertexes are the n points of the contact pattern is the comparison object general area.

For example, the comparison object general area estimation unit 304 according to this exemplary embodiment may derive minx which is the minimum x-coordinate value, maxx which is the maximum x-coordinate value, miny which is the minimum y-coordinate value, and maxy which is the maximum y-coordinate value from the coordinates of the n points. The comparison object general area estimation unit 304 according to this exemplary embodiment may estimate that the area inside the rectangle having four vertexes whose coordinates are (minx, miny), (maxx, miny), (maxx, maxy), and (minx, maxy) is the comparison object general area.

The operation of the image comparison device having the above-mentioned configuration according to the sixth exemplary embodiment of the present invention is different in the operation of steps S43 to S45, in comparison with the comparison object general area estimation process of the image comparison device 3 according to the third exemplary embodiment of the present invention. The image comparison device according to the sixth exemplary embodiment of the present invention acquires the contact pattern including the coordinates of the n points and estimates that a circumscribed rectangle of the polygon whose n vertexes are the n points is the comparison object general area.

Next, the effect of the image comparison device according to the sixth exemplary embodiment of the present invention will be described.

Such image comparison device according to the sixth exemplary embodiment of the present invention estimates the comparison object general area on the basis of a simple contact pattern including the coordinates of the n points. Therefore, the image comparison device according to the sixth exemplary embodiment can reduce the user burden in designating the area which the user desires to take as the comparison object.

The image comparison device according to the sixth exemplary embodiment of the present invention can estimate a wider comparison object general area than that of the image comparison device according to the fifth exemplary embodiment of the present invention. The image comparison device according to the sixth exemplary embodiment of the present invention can ensure high comparison accuracy even when there is small inconsistency between the area which the user desires to take as the comparison object and the area designated by the actual touch operation.

### Seventh Exemplary Embodiment

Next, a seventh exemplary embodiment of the present invention will be described.

The image comparison device according to the seventh exemplary embodiment of the present invention has a configuration that is similar to that of the image comparison device 3 according to the third exemplary embodiment of the present invention. However, the configurations of the contact pattern acquisition unit 303 and the comparison object general area estimation unit 304 are different from those of the image comparison device 3 of the third exemplary embodiment.

The contact pattern acquisition unit 303 according to this exemplary embodiment acquires information representing a curved line as the contact pattern representing the general location of the area which is the comparison object. Here, for ease of explanation, the information acquired as the contact pattern is described as a curved line A.

The comparison object general area estimation unit 304 according to this exemplary embodiment estimates that the inner area of the curved line A acquired as the contact pattern and a curved line B derived by rotating the curved line A around a middle point between a start point and an end point of the curved line A by a predetermined angle θ is the comparison object general area.

Further, the predetermined angle θ is determined in advance so as to satisfy 0 degree<=θ<360 degrees. Especially, a suitable rotation angle θ is for example, 180 degrees. In this case, because the curved line derived by connecting the curved line A and the curved line B is a closed curve, the comparison object general area estimation unit 304 according to this exemplary embodiment may estimate that the area inside the closed curve is the comparison object general area.

The operation of the image comparison device having the above-mentioned configuration according to the seventh exemplary embodiment of the present invention is different in the operation in S43 to S45, in comparison with the comparison object general area estimation process that are performed by the image comparison device 3 according to the third exemplary embodiment of the present invention. The image comparison device of the seventh exemplary embodiment of the present invention acquires the contact pattern representing the curved line A and estimates that the area inside the curved line A and the curved line B derived by rotating the curved line A around the middle point between the start point and the end point of the curved line A by the predetermined angle θ is the comparison object general area.

Further, after the contact pattern acquisition unit 303 according to this exemplary embodiment judges that the general location designation operation has been started in step S42, in step S44, the contact pattern acquisition unit 303 determines whether or not the general location designation operation ends. In step S44, when the continuous touch operation against the display device with coordinates input function 2003 becomes undetected, the contact pattern acquisition unit 303 may judge that the general location designation operation ends.

Next, the effect of the image comparison device according to the seventh exemplary embodiment of the present invention will be described.

Such image comparison device according to the seventh exemplary embodiment of the present invention estimates the comparison object general area on the basis of a simple contact pattern representing one curved line. Therefore, the image comparison device according to the seventh exemplary embodiment can reduce the user burden in designating the area which the user desires to take as the comparison object.

Further, the comparison object general area estimation unit 304 according to this exemplary embodiment may estimate that the area inside the circumscribed rectangle of the area, which is described as the area R, which is surrounded by the curved line A that is the contact pattern and the curved line B derived by rotating the curved line A around the middle point between the start point and the end point of the curved line A by the predetermined angle θ is the comparison object general area.

For example, the comparison object general area estimation unit 304 according to this exemplary embodiment may derive minx which is the minimum x-coordinate value of the area R, maxx which is the maximum x-coordinate value of the area R, miny which is the minimum y coordinate value of the area R, and maxy which is the maximum y coordinate value of the area R. The comparison object general area estimation unit 304 according to this exemplary embodiment may estimate that the area inside the rectangle having four vertexes whose coordinates are (minx, miny), (maxx, miny), (maxx, maxy), and (minx, maxy) is the comparison object general area.

As a result, the image comparison device according to this exemplary embodiment can estimate a wider area than the area inside the area R as the comparison object general area. Accordingly, the image comparison device according to this exemplary embodiment can ensure high comparison accuracy even when there is small inconsistency between the area which the user desires to take as the comparison object and the area designated by the actual touch operation.

### Eighth Exemplary Embodiment

Next, an eighth exemplary embodiment of the present invention will be described.

The image comparison device according to the eighth exemplary embodiment of the present invention has a configuration that is similar to that of the image comparison device 3 according to the third exemplary embodiment of the present invention. However, the configurations of the contact pattern acquisition unit 303 and the comparison object general area estimation unit 304 are different from those of the image comparison device 3 according to the third exemplary embodiment.

The contact pattern acquisition unit 303 according to this exemplary embodiment acquires information representing a curved line as the contact pattern representing the general location of the area which is the comparison object. Here, for ease of explanation, the information acquired as the contact pattern is described as the curved line A.

The comparison object general area estimation unit 304 according to this exemplary embodiment estimates that the area inside the curved line A acquired as the contact pattern and a curved line C which is line-symmetrical to the curved line A with respect to the line connecting the start point and the end point of the curved line A, which is the symmetrical axis, is the comparison object general area.

The curved line derived by connecting the curved line A and the curved line C is a closed curve. The comparison object general area estimation unit 304 according to this exemplary embodiment may estimate that the area inside that closed curve is the comparison object general area.

In steps S43 to S45, The operation of the image comparison device having the above-mentioned configuration according to the eighth exemplary embodiment of the present invention is different in the operation of steps S43 to S45, in comparison with the comparison object general area estimation process of the image comparison device 3 according to the third exemplary embodiment of the present invention. The image comparison device of the eighth exemplary embodiment of the present invention acquires the contact pattern including the curved line A and estimates that the area surrounded by the curved line A and the curved line C, which is line-symmetric to the curved line A with respect to the line connecting the start point and the end point of the curved line A, is the comparison object general area.

Further, after the contact pattern acquisition unit 303 according to this exemplary embodiment judges that the general location designation operation has been started in step S42, in step S44, the contact pattern acquisition unit 303 determines whether or not the general location designation operation ends. In step S44, when the continuous touch operation against the display device with coordinates input function 2003 becomes undetected, the contact pattern acquisition unit 303 may judge that the general location designation operation ends.

Next, the effect of the image comparison device according to the eighth exemplary embodiment of the present invention will be described.

Such image comparison device according to the eighth exemplary embodiment of the present invention estimates the comparison object general area on the basis of a simple contact pattern of one curved line. Therefore, the image comparison device according to the eighth exemplary embodiment can reduce the user burden in designating the area which the user desires to take as the comparison object.

Further, the comparison object general area estimation unit 304 according to this exemplary embodiment may estimate that the area inside the circumscribed rectangle of the area, which is described as R2, which is surrounded by the curved line A that is the contact pattern and the curved line C which is line-symmetric to the curved line A with respect to the line connecting the start point and the end point of the curved line A is the comparison object general area.

For example, the comparison object general area estimation unit 304 according to this exemplary embodiment may derive minx which is the minimum x coordinate value of the area R2, maxx which is the maximum x coordinate value of the area R2, miny which is the minimum y coordinate value of the area R2, and maxy which is the maximum y coordinate value of the area R2. The comparison object general area estimation unit 304 according to this exemplary embodiment may estimate that the area inside the rectangle having four vertexes whose coordinates are (minx, miny), (maxx, miny), (maxx, maxy), and (minx, maxy) is the comparison object general area.

As a result, the image comparison device according to this exemplary embodiment can estimate a wider area than the area inside the area R2 as the comparison object general area. Accordingly, the image comparison device according to this exemplary embodiment can ensure high comparison accuracy even when there is small inconsistency between the area which the user desires to take as the comparison object and the area designated by the actual touch operation.

### Ninth Exemplary Embodiment

Next, a ninth exemplary embodiment of the present invention will be described.

The image comparison device according to the ninth exemplary embodiment of the present invention has a configuration that is similar to that of the image comparison device 3 according to the third exemplary embodiment of the present invention. However, the configurations of the contact pattern acquisition unit 303 and the comparison object general area estimation unit 304 are different from those of the image comparison device 3 according to the third exemplary embodiment.

The contact pattern acquisition unit 303 according to this exemplary embodiment acquires information representing a line which makes a closed area as the contact pattern representing the general location of the area which is the comparison object.

The comparison object general area estimation unit 304 according to this exemplary embodiment estimates that the area inside the line which makes the closed area is the comparison object general area.

In steps S43 to S45, The operation of the image comparison device having the above-mentioned configuration according to the ninth exemplary embodiment of the present invention is different in the operation in steps S43 to S45, in comparison with the comparison object general area estimation process of the image comparison device 3 according to the third exemplary embodiment of the present invention. The image comparison device according to the ninth exemplary embodiment of the present invention acquires the contact pattern representing the line which makes the closed area, and estimates that the area inside the line which makes the closed area is the comparison object general area.

Further, after the contact pattern acquisition unit 303 according to this exemplary embodiment judges that the general location designation operation has been started in step S42, in step S44, the contact pattern acquisition unit 303 determines whether or not the general location designation operation ends. In step S44, while the contact pattern acquisition unit 303 continuously detects the operation to touch the display device with coordinates input function 2003, when the same contact location as a contact location included in the history of contact locations in the past is detected, the contact pattern acquisition unit 303 may judge that the general location designation operation ends.

Next, the effect of the image comparison device according to the ninth exemplary embodiment of the present invention will be described.

Such image comparison device according to the ninth exemplary embodiment of the present invention estimates the comparison object general area on the basis of a simple contact pattern representing the line of which the closed area is composed. Therefore, the image comparison device according to the ninth exemplary embodiment can reduce the user burden in designating the area which the user desires to take as the comparison object.

### Tenth Exemplary Embodiment

Next, a tenth exemplary embodiment of the present invention will be described.

The image comparison device according to the tenth exemplary embodiment of the present invention has a configuration that is similar to that of the image comparison device 3 according to the third exemplary embodiment of the present invention. However, the configurations of the contact pattern acquisition unit 303 and the comparison object general area estimation unit 304 are different from those of the image comparison device 3 according to the third exemplary embodiment.

The contact pattern acquisition unit 303 according to this exemplary embodiment acquires information representing a curved line as the contact pattern representing the general location of the area which is the comparison object. Here, for ease of explanation, the information acquired as the contact pattern is described as the curved line A.

The comparison object general area estimation unit 304 according to this exemplary embodiment considers the curved line A acquired as the contact pattern as connected two straight line segments (that is an L-shaped line), and estimates that the area inside the parallelogram whose two sides are the two line segments is the comparison object general area.

For example, the comparison object general area estimation unit 304 according to this exemplary embodiment may detect an inflection point of the curved line A. The comparison object general area estimation unit 304 may consider the curved line A as the L-shaped line made up of connected two line segments which are a line segment connecting the start point and the inflection point and a line segment connecting the inflection point and the end point.

In this case, for example, the comparison object general area estimation unit 304 according to this exemplary embodiment may detect a point at which the curvature of the curved line A is the maximum as the inflection point.

Further, the comparison object general area estimation unit 304 according to this exemplary embodiment analyzes the history of the contact locations in time order, and may consider, as the inflection point, a location at which a rate of change in tracks of the contact location in a predetermined time, that is input speed of the contact pattern, is the minimum. That is because when the user performs the touch operation so as to write a letter “L” on the display, it is reasonable that a moving speed of the user's finger, a stylus, or the like becomes slow in the vicinity of the connection point of two line segments of which the L-shaped line is made up.

The operation of the image comparison device having the above-mentioned configuration according to the tenth exemplary embodiment of the present invention is different in the operation in steps S43 to S45, in comparison with the comparison object general area estimation process of the image comparison device 3 according to the third exemplary embodiment of the present invention. The image comparison device according to the tenth exemplary embodiment of the present invention acquires the contact pattern representing the curved line A, considers the curved line A as connected two line segments (that is an L-shaped line), and estimates that the area inside the parallelogram whose two sides are the two line segments is the comparison object general area.

Further, after the contact pattern acquisition unit 303 according to this exemplary embodiment judges that the general location designation operation has been started in step S42, in step S44, the contact pattern acquisition unit 303 determines whether or not the general location designation operation ends. In step S44, when the continuous touch operation against the display device with coordinates input function 2003 becomes undetected, the contact pattern acquisition unit 303 may judge that the general location designation operation ends.

Next, the effect of the image comparison device according to the tenth exemplary embodiment of the present invention will be described.

Such image comparison device according to the tenth exemplary embodiment of the present invention estimates the comparison object general area on the basis of a simple contact pattern representing a curved line that can be considered as an L-shaped line. Therefore, the image comparison device according to the tenth exemplary embodiment can reduce the user burden in designating the area which the user desires to take as the comparison object.

Further, the comparison object general area estimation unit 304 according to this exemplary embodiment may consider the curved line A which is the contact pattern as connected two line segments, that is an L-shaped line, and may estimate that the area inside a circumscribed rectangle of the parallelogram whose two sides are the two line segments is the comparison object general area.

For example, the comparison object general area estimation unit 304 according to this exemplary embodiment may derive minx which is the minimum x-coordinate value, maxx which is the maximum x-coordinate value, miny which is the minimum y-coordinate value, and maxy which is the maximum y-coordinate value, from the coordinates of the vertexes P1, P2, P3, and P4 of the parallelogram whose two sides are the two line segments of which the L-shaped line is made up. The comparison object general area estimation unit 304 according to this exemplary embodiment may estimate that the area inside the rectangle having four vertexes whose coordinates are (minx, miny), (maxx, miny), (maxx, maxy), and (minx, maxy) is the comparison object general area.

As a result, the image comparison device according to this exemplary embodiment can estimate a wider area than the area inside the parallelogram whose two sides are the two line segments of which the L-shaped line is made up. Accordingly, the image comparison device according to this exemplary embodiment can ensure high comparison accuracy even when there is small inconsistency between the area which the user desires to take as the comparison object and the area designated by the actual touch operation.

### Eleventh Exemplary Embodiment

Next, an eleventh exemplary embodiment of the present invention will be described in detail with reference to the drawing. Further, in each drawing referred to in the description of this exemplary embodiment, the same reference numbers are used for the same components and the same operation steps as those of the second exemplary embodiment of the present invention, and the detailed description will be omitted in this exemplary embodiment.

First, an image comparison device 4 according to the eleventh exemplary embodiment of the present invention is composed using the computer device which is a component of the image comparison device 2 according to the second exemplary embodiment of the present invention shown in FIG. 6.

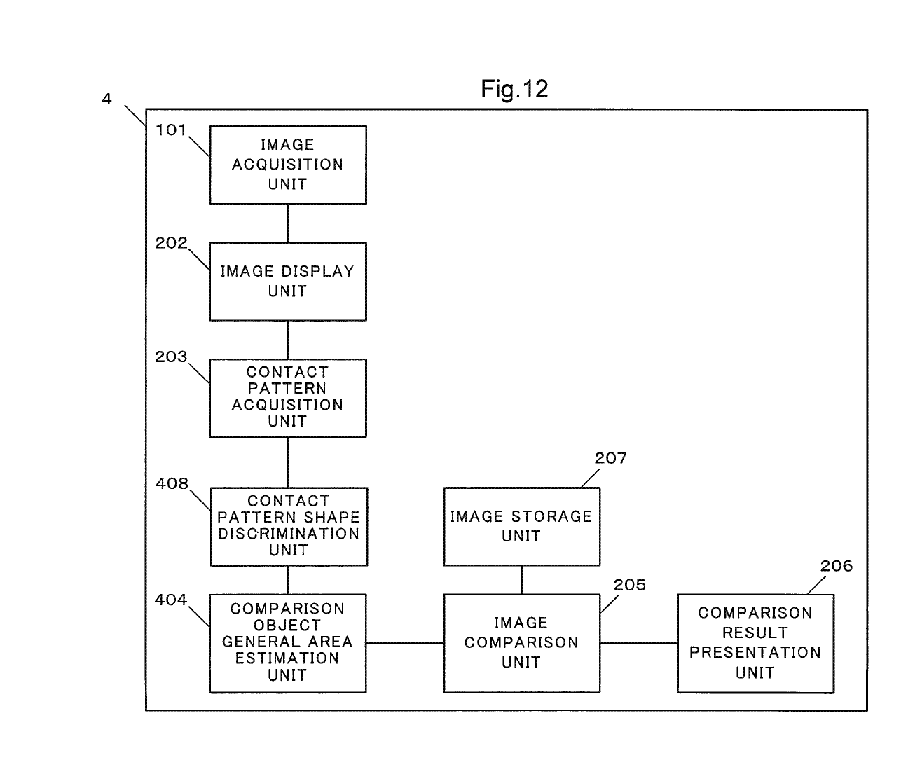

Next, a functional block diagram of the image comparison device 4 is shown in FIG. 12.

The image comparison device 4 is different in including a comparison object general area estimation unit 404 instead of the comparison object general area estimation unit 104, and further including a contact pattern shape discrimination unit 408, in comparison with the image comparison device 2 according to the second exemplary embodiment of the present invention. Here, the contact pattern shape discrimination unit 408 is composed using the control unit 1001. Further, the hardware configuration of each functional block of the image comparison device 4 is not limited to the above-mentioned configuration.

The contact pattern shape discrimination unit 408 discriminates the shape of the contact pattern acquired by the contact pattern acquisition unit 203.

For example, the contact pattern shape discrimination unit 408 may discriminate whether the contact pattern is one or more points, or a line. Specifically, for example, the contact pattern shape discrimination unit 408 assigns, to each pixel (coordinates), a code for discriminating between a pixel (coordinates) that belongs to the contact pattern and a pixel (coordinates) that does not belong to the contact pattern. The contact pattern shape discrimination unit 408 may extract a connected region composed of the pixels which belong to the contact pattern and discriminate whether the contact pattern is one or more points, or a line, on the basis of the number the connected regions and the number of the pixels included in each connected region.

Further, when the contact pattern shape discrimination unit 408 judges the contact pattern to be composed of one or more points, the contact pattern shape discrimination unit 408 may determine the number of points. Specifically, for example, the contact pattern shape discrimination unit 408 may use the number of the above-mentioned connected regions as the number of the points.

Further, when the contact pattern shape discrimination unit 408 judges that the contact pattern is made up of a line, the contact pattern shape discrimination unit 408 may determine a type of the line, such as a closed curve, an L-shaped line, or other type of line.

The comparison object general area estimation unit 404 estimates the comparison object general area on the basis of the shape of the contact pattern discriminated by the contact pattern shape discrimination unit 408.

For example, when it is judged that the shape of the contact pattern is one point, the comparison object general area estimation unit 404 may estimate that the area inside the rectangle having four vertexes that are located at positions whose distances from the one point are respectively predetermined is the comparison object general area.

Further, for example, when it is judged that the shape of the contact pattern is two points, the comparison object general area estimation unit 404 may estimate that the area inside the rectangle whose diagonal is a line connecting the two points is the comparison object general area.

Further, for example, when it is judged that the shape of the contact pattern is three points, the comparison object general area estimation unit 404 may estimate that the area inside the parallelogram whose vertexes include the three points or the area inside the circumscribed rectangle of the parallelogram is the comparison object general area.

Further, for example, when it is judged that the shape of the contact pattern is four or more points, the comparison object general area estimation unit 404 may estimate that the area inside the polygon whose vertexes are the four or more points or the area inside the circumscribed rectangle of the polygon is the comparison object general area.

Further, for example, when it is judged that the shape of the contact pattern is a closed curve, the comparison object general area estimation unit 404 may estimate that the area inside the closed curve or the area inside the circumscribed rectangle of the closed curve is the comparison object general area.

Further, for example, when the shape of the contact pattern is a line other than the closed curve, which can be considered as an L-shaped line, the comparison object general area estimation unit 404 may estimate that the area inside the parallelogram whose two sides are the two lines of which the L-shaped line is made up or the area inside the circumscribed rectangle of the parallelogram is the comparison object general area.

Further, for example, when the shape of the contact pattern is a line other than a closed curve (that is curved line A), which can not be considered as an L-shaped line, the comparison object general area estimation unit 404 may generate the curved line B derived by rotating the curved line A around the middle point between the start point and the end point of the curved line A by a predetermined angle. The comparison object general area estimation unit 404 may estimate that the area surrounded by the curved line A and the curved line B is the comparison object general area. Further, in this case, the comparison object general area estimation unit 404 may estimate that the area surrounded by the curved line A and a curved line C, which is line-symmetrical to the curved line A with respect to the line connecting the start point and the end point of the curved line A, is the comparison object general area.

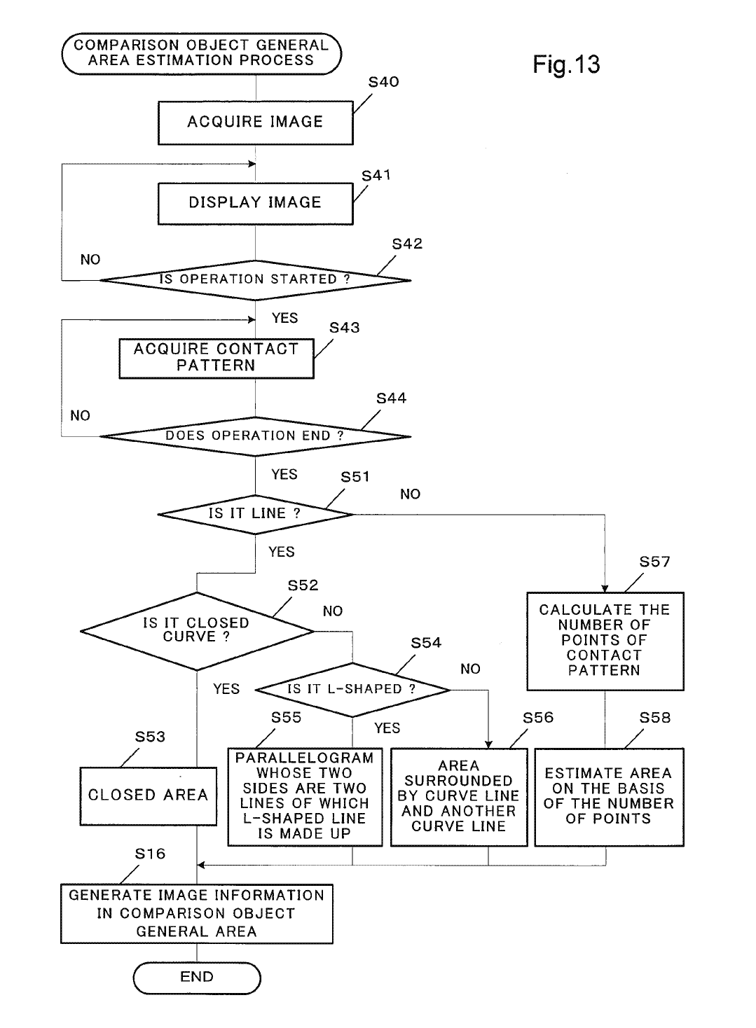

The comparison object general area estimation operation performed by the image comparison device 4 having the above-mentioned configuration will be described by using FIG. 13. Further, because the registration process and the search process performed by the image comparison device 4 are the same as those of the image comparison device 2 according to the second exemplary embodiment of the present invention, the explanation will be omitted in this exemplary embodiment.

In FIG. 13, the image comparison device 4 acquires the contact pattern by performing the operations of steps S40 to S44 like the image comparison device 2 according to the second exemplary embodiment of the present invention.

Further, the contact pattern acquisition unit 203 may display an end button to finish the area designation operation in the display device with coordinates input function 2003 at the time of starting the area designation operation. It is preferable that when the contact pattern acquisition unit 203 senses the touch operation to the end button area in step S44, the contact pattern acquisition unit 203 judges that the area designation operation ends.

Next, the contact pattern shape discrimination unit 408 discriminates whether the shape of the contact patter is one or more points, or a line (step S51).

For example, as described above, the contact pattern shape discrimination unit 408 may discriminate whether the contact patter is one or more points, or a line, on the basis of the number of the connected regions of the pixels which belongs to the contact pattern and the number of pixels in each connected region.

In step S51, when the contact pattern shape discrimination unit 408 judges that the contact pattern is a line, the contact pattern shape discrimination unit 408 discriminates whether or not the shape of the contact pattern is a closed curve (step S52).

For example, the contact pattern shape discrimination unit 408 traces a contour with respect to the pixel of the contact pattern. And, when the contact pattern shape discrimination unit 408 detects a loop, the contact pattern shape discrimination unit 408 judges the contact pattern as a closed curve.

In step S52, when the contact pattern shape discrimination unit 408 judges that the contact pattern is a closed curve, the comparison object general area estimation unit 404 estimates that the closed area inside the closed curve or the area inside the circumscribed rectangle of the closed area is the comparison object general area (step S53).

On the other hand, in step S52, when the contact pattern shape discrimination unit 408 judges that the contact pattern is not a closed curve, the contact pattern shape discrimination unit 408 discriminates whether or not the shape of the contact pattern is L-shaped (step S54).

For example, the contact pattern shape discrimination unit 408 may discriminate whether or not the shape of the contact pattern is L-shaped on the basis of whether or not the inflection point is detected as described in the tenth exemplary embodiment of the present invention.

In step S54, when the contact pattern shape discrimination unit 408 judges that the shape of the contact pattern is L-shaped, the comparison object general area estimation unit 404 estimates that the area inside the parallelogram whose two sides are the two line segments of which the L-shaped line is made up or the area inside the circumscribed rectangle of the parallelogram is the comparison object general area (step S55).

On the other hand, in step S54, when the contact pattern shape discrimination unit 408 judges that the shape of the contact pattern is not L-shaped, the comparison object general area estimation unit 404 generates the above-mentioned curved line B or the above-mentioned curved line C from the shape of the contact pattern (that is the curved line A). The comparison object general area estimation unit 404 estimates that the area surrounded by the curved line A and the curved line B that are mentioned above or the area surrounded by the curved line A and the curved line C that are mentioned above is the comparison object general area (step S56).

Further, in step S51, when the contact pattern shape discrimination unit 408 judges that the shape of the contact pattern is one or more points, the contact pattern shape discrimination unit 408 derives the number of the points (step S57).

Next, the comparison object general area estimation unit 404 estimates the comparison object general area on the basis of the number of the points that is derived in step S57 (step S58).

For example, when the number of the points that is derived in step S57 is one, the comparison object general area estimation unit 404 may estimate that the area inside the rectangle having four vertexes which are located at positions whose distances from the one point is respectively predetermined is the comparison object general area.

Further, for example, when the number of the points that is derived in step S57 is two, the comparison object general area estimation unit 404 may estimate that the area inside the rectangle whose diagonal is the line connecting the two points is the comparison object general area.

Further, for example, when the number of the points that is derived in step S57 is three, the comparison object general area estimation unit 404 may estimate that the area inside the parallelogram whose vertexes include the three points or the area inside the circumscribed rectangle of the parallelogram is the comparison object general area.

Further, for example, when the number of the points that is derived in step S57 is four or more, the comparison object general area estimation unit 404 may estimate that the area inside the polygon whose vertexes include the four or more points or the area inside the circumscribed rectangle of the polygon is the comparison object general area.

Next, the comparison object general area estimation unit 404 generates information representing the image in the estimated comparison object general area (step S16).

And, the comparison object general area estimation process of the image comparison device 4 ends.

Next, the effect of the image comparison device according to the eleventh exemplary embodiment of the present invention will be described.

The comparison accuracy and the processing speed when searching for the registered image corresponding to the search image by using a technique to derive the integrated comparison result using the comparison results for the individual local areas can be improved by the image comparison device according to the eleventh exemplary embodiment of the present invention. Further, the image comparison device according to the eleventh exemplary embodiment of the present invention can reduce a user burden in designating the comparison object general area in the image which is the comparison object.

The reason is that the contact pattern shape discrimination unit discriminates the shape of the contact pattern and the comparison object general area estimation unit estimates the comparison object general area on the basis of the shape of the contact pattern. Accordingly, in the image comparison device according to the eleventh exemplary embodiment of the present invention, a flexibility of the user's touch operation for designating the area which the user desires to take as the comparison object can be made high.

### Twelfth Exemplary Embodiment

Next, a twelfth exemplary embodiment of the present invention will be described in detail with reference to the drawing. Further, in each drawing referred to in the description of this exemplary embodiment, the same reference numbers are used for the same components and the same operation steps as those of the second exemplary embodiment of the present invention and the detailed description will be omitted in this exemplary embodiment.

First, an image comparison device 5 according to the twelfth exemplary embodiment of the present invention is composed using the computer device of the image comparison device 2 according to the second exemplary embodiment of the present invention shown in FIG. 6.

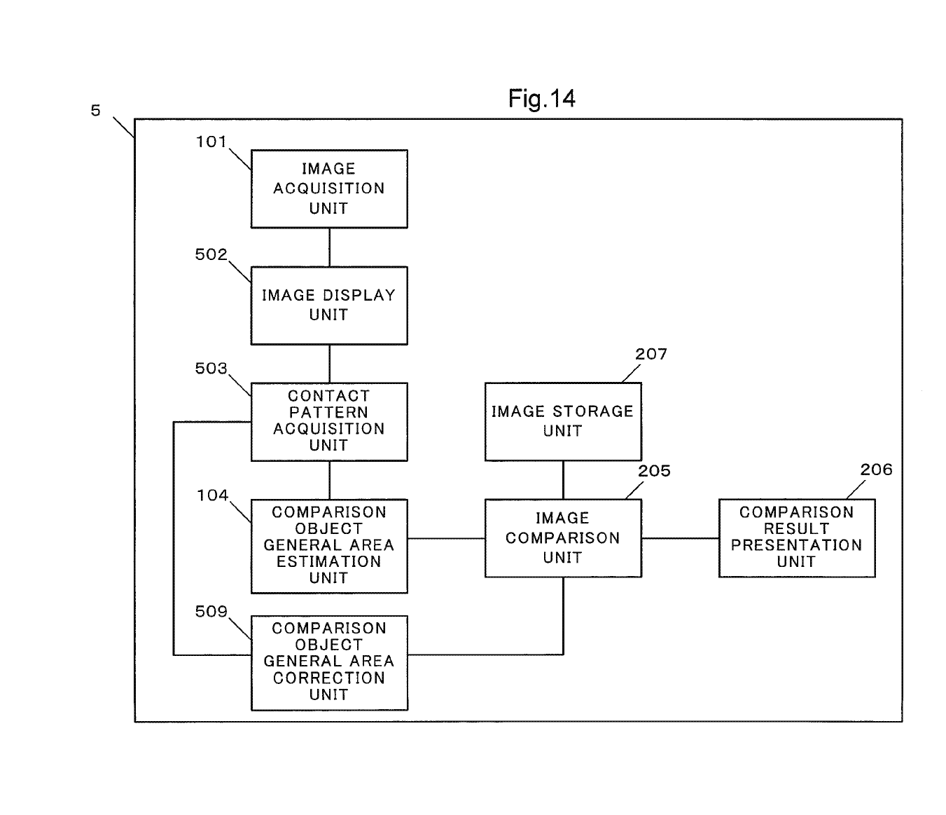

Next, a functional block diagram of the image comparison device 5 is shown in FIG. 14.

In FIG. 14, in comparison with the image comparison device 2 according to the second exemplary embodiment of the present invention, the image comparison device 5 includes an image display unit 502 instead of the image display unit 202 and a contact pattern acquisition unit 503 instead of the contact pattern acquisition unit 203, and further includes a comparison object general area correction unit 509.

Here, the comparison object general area correction unit 509 is composed using the control unit 1001. Further, the hardware configuration of each functional block of the image comparison device 5 is not limited to the above-mentioned configuration.

The image display unit 502 has a configuration that is the same as that of the image display unit 202 according to the second exemplary embodiment of the present invention. Additionally, the image display unit 502 displays the comparison object general area estimated by the comparison object general area estimation unit 104 superimposing the comparison object general area on the previously displayed image.

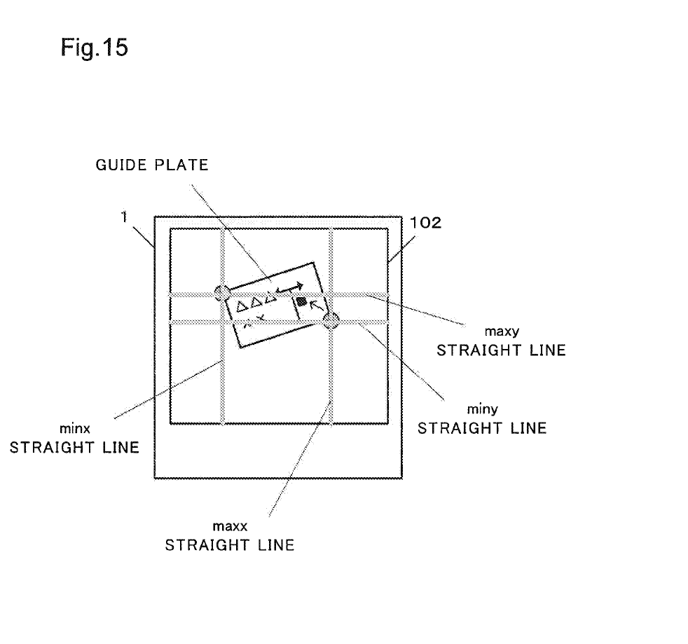

One example of the comparison object general area that is superimposed on the image and displayed by the image display unit 502 is shown in FIG. 15. In FIG. 15, the image display unit 502 displays four straight lines surrounding the comparison object general area superimposing the four straight lines on the image. When the lower left vertex of the image in FIG. 8 is taken as the origin, the horizontal axis (whose right side is positive) is the x axis and the vertical axis (whose upper side is positive) is the y axis. The image display unit 502 may display, as four straight lines, a minx straight line expressed by an equation of x=minx, a maxx straight line expressed by an equation of x=maxx, a miny straight line expressed by an equation of y=miny, and a maxy straight line expressed by an equation of y=maxy. Further, the image display unit 502 may arbitrarily set in advance the location of the origin, the direction of the axis, and the like, as described above.

The contact pattern acquisition unit 503 has a configuration which is similar to that of the contact pattern acquisition unit 203 according to the second exemplary embodiment of the present invention. Additionally, the contact pattern acquisition unit 503 acquires a correction contact pattern for correcting the comparison object general area. Further, the correction contact pattern is one exemplary embodiment of a correction location pattern in the present invention.

For example, the contact pattern acquisition unit 503 may acquire, as the correction contact pattern, a locus of the contact location that is acquired through the display device with coordinates input function 2003.

The comparison object general area correction unit 509 corrects the comparison object general area on the basis of the correction contact pattern acquired by the contact pattern acquisition unit 503.

For example, the comparison object general area correction unit 509 may select, among four straight lines displayed by the image display unit 502, a straight line located in the vicinity of the start point of the locus that is the correction contact pattern acquired by the contact pattern acquisition unit 503. In this case, the comparison object general area correction unit 509 may derive a movement vector on the basis of the start point and the end point of the locus, and may correct the location of the selected straight line on the basis of the movement vector.

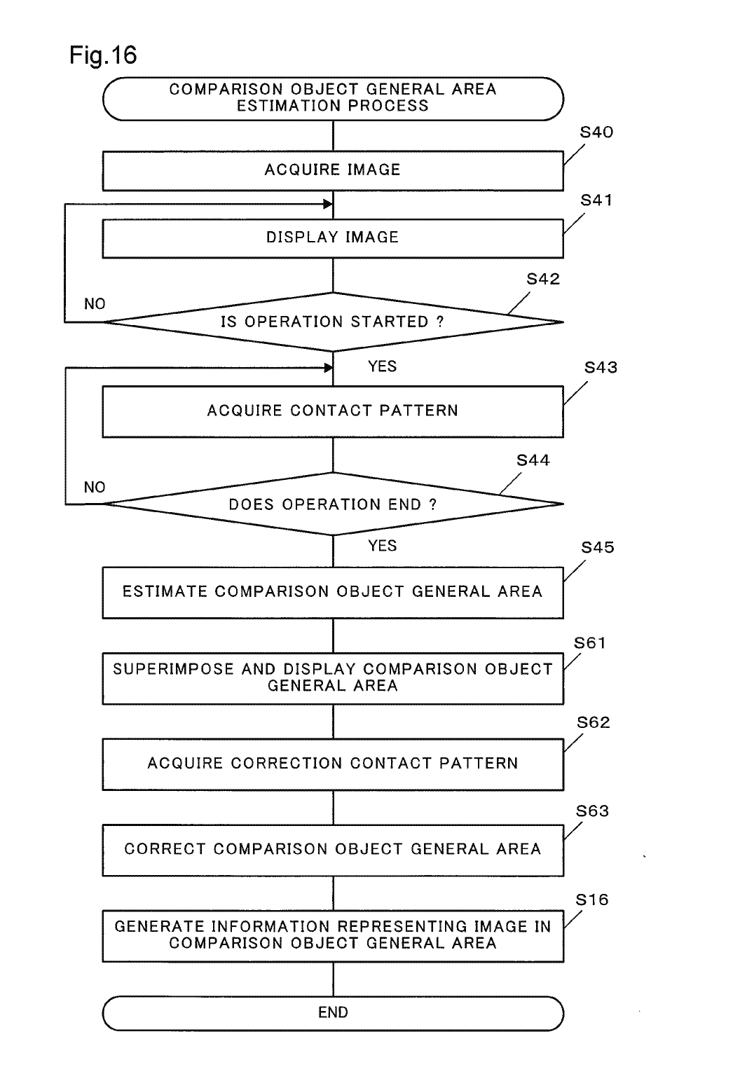

The comparison object general area estimation operation performed by the image comparison device 5 having the above-mentioned configuration will be described by using FIG. 16.

Further, because the registration process and the search process performed by the image comparison device 5 are similar to those performed by the image comparison device 2 according to the second exemplary embodiment of the present invention, the description will be omitted in this exemplary embodiment.

In FIG. 16, the image comparison device 5 performs the operations of steps S40 to S45 and estimates the comparison object general area on the basis of the contact pattern like the image comparison device 2 according to the second exemplary embodiment of the present invention.

Next, the image display unit 502 displays the comparison object general area estimated by the comparison object general area estimation unit 104 in step S45 superimposing the comparison object general area on the previously displayed image (step S61).

For example, the image display unit 502 may display four straight lines representing the outline of the comparison object general area.

Next, the contact pattern acquisition unit 503 acquires the correction contact pattern for correcting the comparison object general area (step S62).

For example, the contact pattern acquisition unit 503 may acquire the locus of the contact location as the correction contact pattern.

Further, the contact pattern acquisition unit 503 repeats the process of step S62 until it is judged that the area correction operation ends. At that time, for example, when the contact pattern acquisition unit 503 senses the touch operation to a correction completion button area displayed in the image display unit 502, the contact pattern acquisition unit 503 may judge that the area correction operation ends.

Next, the comparison object general area correction unit 509 corrects the comparison object general area on the basis of the correction contact pattern (step S63).

For example, the comparison object general area correction unit 509 may select one of four straight lines on the basis of the locus that is the correction contact pattern. Further, the comparison object general area correction unit 509 may derive the movement vector on the basis of the start point and the end point of the locus and correct the location of the selected straight line on the basis of the derived movement vector.

After this process, like the image comparison device 2 according to the second exemplary embodiment of the present invention, the image comparison device 5 performs the operation to generate information representing the image in the comparison object general area, which is corrected.

And, the comparison object general area estimation process performed by the image comparison device 5 ends.

Next, the effect of the twelfth exemplary embodiment of the present invention will be described.

In the image comparison device according to the twelfth exemplary embodiment of the present invention, the comparison accuracy in the case of deriving the integrated comparison result using the comparison results for the individual local areas can be further improved.

The reason is that the comparison object general area correction unit corrects the comparison object general area which is estimated as the general area which is the comparison object once. As a result, the image comparison device according to the twelfth exemplary embodiment of the present invention can derive the integrated comparison result on the basis of comparison results for individual local areas using the corrected comparison object general area, and can derive the comparison result with higher accuracy.

### Thirteenth Exemplary Embodiment

Next, a thirteenth exemplary embodiment of the present invention will be described in detail with reference to the drawing. Further, in each drawing referred to in the description of this exemplary embodiment, the same reference numbers are used for the same components and the same operation steps as those of the first exemplary embodiment of the present invention and the detailed description will be omitted in this exemplary embodiment.

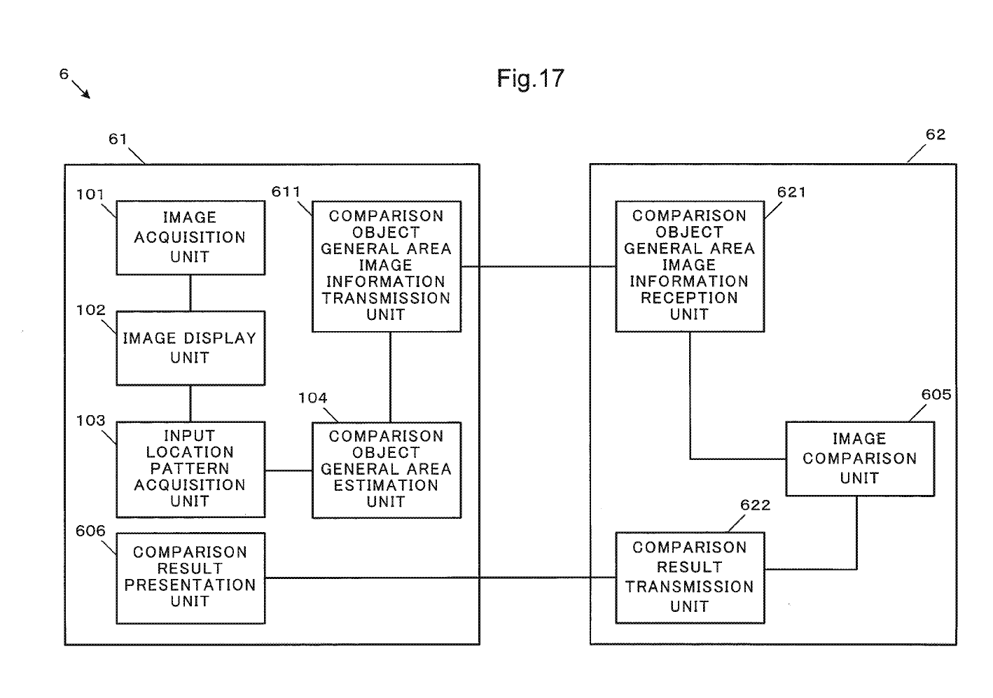

First, a configuration of an image comparison system 6 according to the thirteenth exemplary embodiment of the present invention will be described with reference to FIG. 17.

In FIG. 17, the image comparison system 6 includes a terminal 61 and a server 62. The terminal 61 and the server 62 are connected so as to communicate with each other through a network realized by the internet, a LAN (Local Area Network), a public line network, a wireless communication network, or a combination of those networks.

The terminal 61 includes the image acquisition unit 101, the image display unit 102, the input location pattern acquisition unit 103, the comparison object general area estimation unit 104, a comparison object general area image information transmission unit 611, and a comparison result presentation unit 606.

The terminal 61 is composed using a general-purpose computer including a control unit including a CPU, a RAM, and a ROM, a storage device such as a hard disk or the like, an input device, a display device, and a network interface. Further, the control unit reads a computer program stored in the ROM or the storage device, stores the computer program in the RAM, and executes the computer program by the CPU in order to cause the computer device to function as the terminal 61.

The comparison object general area image information transmission unit 611 is composed using the network interface and the control unit. Further, the comparison result presentation unit 606 is composed using the display device, the network interface, and the control unit.

The server 62 includes a comparison object general area image information reception unit 621, an image comparison unit 605, and a comparison result transmission unit 622.

The server 62 is composed using a general-purpose computer device including the control unit including a CPU, a RAM, and a ROM, a storage device such as a hard disk or the like, and a network interface. Further, the control unit reads a computer program stored in the ROM or the storage device, stores the computer program in the RAM, and executes the computer program by the CPU in order to cause the computer device to function as the server 62.

The comparison object general area image information reception unit 621 and the comparison result transmission unit 622 are composed using the network interface and the control unit.

Further, the hardware configuration of each functional block of the terminal 61 and the server 62 is not limited to the above-mentioned configuration.

The comparison object general area image information transmission unit 611 of the terminal 61 transmits information representing the image in the comparison object general area estimated by the comparison object general area estimation unit 104 in the image acquired by the image acquisition unit 101 to the server 62.

For example, the comparison object general area image information transmission unit 611 may transmit the image in the comparison object general area that is cut out from the image acquired by the image acquisition unit 101 as the information representing the image in the comparison object general area. Further, the comparison object general area image information transmission unit 611 may transmit a combination of the whole area of the image acquired by the image acquisition unit 101 and the information representing the comparison object general area as the information representing the image in the comparison object general area. Further, the comparison object general area image information transmission unit 611 may transmit the image feature value in the comparison object general area of the image acquired by the image acquisition unit 101 as the information representing the image in the comparison object general area.

The comparison object general area image information transmission unit 611 may transmit the information representing the image in the comparison object general area of a certain image as the information representing the search image. Further, the comparison object general area image information transmission unit 611 may transmit the information representing the image in the comparison object general area of another image as the information representing the registered image.

The comparison result presentation unit 606 receives and displays the integrated comparison result about the information representing the image in the comparison object general area that is transmitted to the server from the server.

The integrated comparison result may be, for example, an index representing a degree of consistency between the search image transmitted to the server and the registered image.

The comparison object general area image information reception unit 621 of the server 62 receives the information representing the image in the comparison object general area of the image which is the comparison object from the terminal 61.

The image comparison unit 605 takes, as the information representing at least one of the search image and the registered image, the information representing the image in the comparison object general area received by the comparison object general area image information reception unit 621.

The image comparison unit 605 derives the integrated comparison result on the basis of comparison results for individual local areas with respect to the search image and the registered image.

Further, with respect to the information used by the image comparison unit 605, one of the information representing the search image and the information representing the registered image may be the information that is not received by the comparison object general area image information reception unit 621. In this case, the image comparison unit 605 may use information on another image that is stored in the storage device or the memory in advance or information representing the whole area of another image received from the terminal 61 as one of the information representing the search image and the information representing the registered image.

The comparison result transmission unit 622 transmits the integrated comparison result between the search image and the registered image, which is derived by the image comparison unit 605, to the terminal 61.

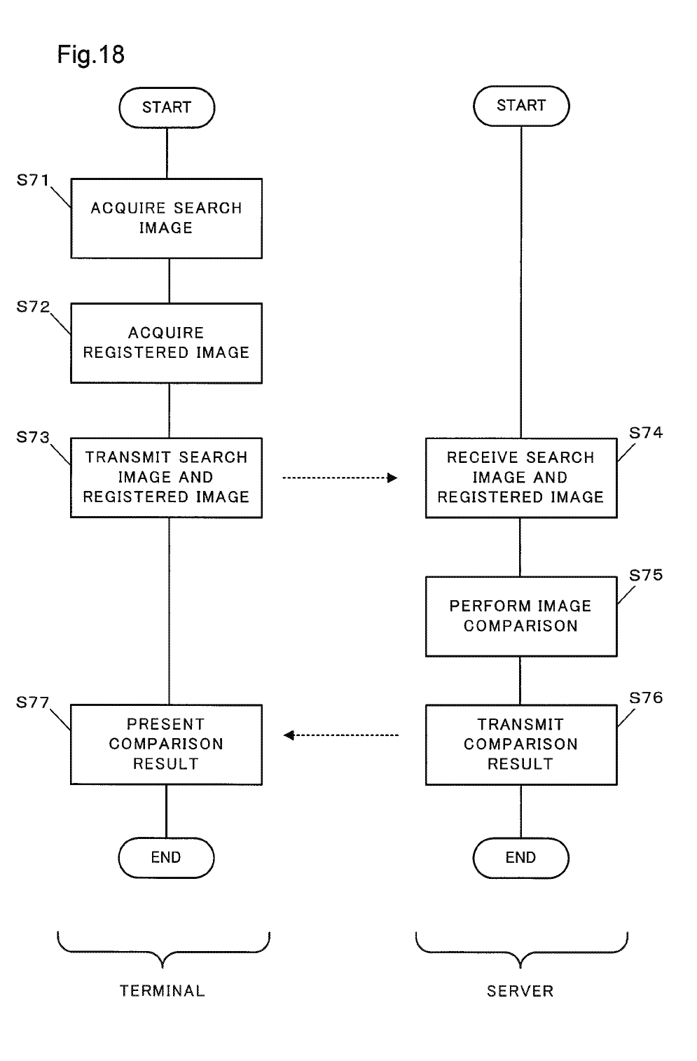

The operation of the image comparison system 6 having the above-mentioned configuration will be described with reference to FIG. 18. Further, in FIG. 18, the operation of the terminal 61 is shown in the left figure, the operation of the server 62 is shown in the right figure, and the dashed arrow shows the direction of data flow.

First, the image acquisition unit 101 and the comparison object general area estimation unit 104 of the terminal 61 acquire the information representing the search image (step S71).

The terminal 61 may acquire the information representing the whole area of the image acquired by the image acquisition unit 101 as the information representing the search image. Further, the terminal 61 may acquire, as the information representing the search image, the information representing the image in the comparison object general area estimated by the comparison object general area estimation process that has been explained by using FIG. 5. Further, the terminal 61 may acquire, as the information representing the search image, the image feature value of the whole area of the image acquired by the image acquisition unit 101 or the feature value of the image in the comparison object general area.

Next, the image acquisition unit 101 and the comparison object general area estimation unit 104 of the terminal 61 acquire the information representing the registered image (step S72).

The terminal 61 may acquire the information representing the whole area of the image acquired by the image acquisition unit 101 as the information representing the registered image. Further, the terminal 61 may acquire, as the information representing the registered image, the information representing the image in the comparison object general area estimated by the comparison object general area estimation process that has been explained by using FIG. 5. Further, the terminal 61 may acquire, as the information representing the registered image, the image feature value of the whole area of the image acquired by the image acquisition unit 101 or the feature value of the image in the comparison object general area.

However, when the information representing the whole area of the image acquired by the image acquisition unit 101 is acquired as the information representing the search image in step S71, the information representing the image in the comparison object general area estimated by the comparison object general area estimation process that has been explained by using FIG. 5 is acquired as the information representing the registered image.

Next, the comparison object general area image information transmission unit 611 of the terminal 61 transmits the information representing the search image acquired in step S71 and the information representing the registered image acquired in step S72 to the server 62 (step S73).

Next, the comparison object general area image information reception unit 621 of the server 62 receives the information representing the search image and the registered image from the terminal 61 (step S74).

Next, the image comparison unit 105 derives the integrated comparison result on the basis of comparison results for individual local areas with respect to the search image and the registered image (step S75).

The image comparison unit 105 may derive the image feature values from the search image and the registered image and may derive the integrated comparison result using the derived image feature values with respect to the search image and the registered image. Further, when the image feature values is acquired as the information representing the search image and the registered image in step S74, the image comparison unit 105 may derive the integrated comparison result using the acquired image feature values with respect to the search image and the registered image.

Next, the comparison result transmission unit 622 transmits the integrated comparison result derived in step S75 to the terminal 61 (step S76).

Next, the comparison result presentation unit 606 of the terminal 61 presents the received integrated comparison result (step S77).

And, the operation of the image comparison system 6 ends.

Further, in the above-mentioned process, the terminal 61 may not perform one of the processes of steps S71 and S72. In this case, in step S75, the server 62 uses either the information representing the search image or the information representing the registered image as the information on another image that is stored in the storage device or the memory in advance.

Next, the effect of the thirteenth exemplary embodiment of the present invention will be described.

The image comparison system according to the thirteenth exemplary embodiment of the present invention can improve the comparison accuracy and the processing speed when driving the integrated comparison result using the comparison results with respect to the individual local areas.

The reason is that the comparison object general area estimation unit of the terminal estimates the general area which is the comparison object in the image which is the comparison object. Further, the reason is that the image comparison unit of the server derives the integrated comparison result on the basis of comparison results for individual local areas using only the image in the comparison object general area as the comparison object with respect to the image to which the comparison object general area is estimated. Accordingly, it is not required that the image comparison unit performs the comparison operation for the area other than the comparison object general area. Therefore, the integrated comparison result is not affected by a comparison result for a local area included in the area other than the comparison object general area, and as a result, the comparison accuracy can be improved. Further, because it is not necessary to perform the comparison operation to the area other than the comparison object general area, the processing speed can be improved.

Further, in the thirteenth exemplary embodiment of the present invention, the server 62 may include an image storage unit which stores the information representing the registered image.

In this case, the image storage unit may store the information representing the image in the comparison object general area that is estimated by the terminal 61 as the information representing the registered image. Further, the image storage unit may store the information representing the whole area of the image that is acquired by the terminal 61 as the information representing the registered image without change. Further, the image storage unit may store the information representing the registered image that is acquired from another device in advance. Further, the image storage unit may store the image feature values derived from those registered images as the information representing the registered image.

In this case, the image comparison system 6 operates as follows.

First, the comparison object general area image information transmission unit 611 of the terminal 61 transmits the information, which represents the image in the comparison object general area of the image acquired by the image acquisition unit 101, to the server 62 as the information representing the search image.

The image comparison unit 605 of the server 62 specifies, among the images stored in the image storage unit, the registered image corresponding to the search image received by the comparison object general area image information reception unit 621.

The comparison result transmission unit 622 transmits the information representing the specified registered image to the terminal 61.

The comparison result presentation unit 606 of the terminal 61 presents the information representing the registered image received from the server 62.

In the thirteenth exemplary embodiment of the present invention, the display device and the input device of the terminal 61 can be composed using a device which can detect the contact location at which the user contacts with the display area during the touch operation. In this case, the input location pattern acquisition unit 103 may acquire the contact pattern representing the pattern of the contact location as the input location pattern.

In the thirteenth exemplary embodiment of the present invention, the terminal 61 may include the contact pattern shape discrimination unit according to the eleventh exemplary embodiment of the present invention and the comparison object general area correction unit according to the twelfth exemplary embodiment of the present invention.

As described above, in the image comparison system 6 according to the thirteenth exemplary embodiment of the present invention, each functional block of the image comparison device according to each exemplary embodiment of the present invention is arranged in the terminal or the server separately.

Usually, the server has a high processing power compared with the terminal. Therefore, the configuration according to the thirteenth exemplary embodiment of the present invention in which the server includes the image comparison unit which performs relatively many calculations is suitable for performing a series of the image comparison processing while the server and the terminal cooperate with each other. Further, usually, the terminal has an better portability compared with the server. Therefore, the configuration according to the thirteenth exemplary embodiment of the present invention, in which the terminal includes the image acquisition unit, the image display unit, and the input location pattern acquisition unit, has an advantage that the user can take an image at various places.

Further, the arrangement and the configuration of each functional block provided in the image comparison system of the present invention is not limited to the arrangement and the configuration according to the thirteenth exemplary embodiment of the present invention. The each functional block can be arbitrary arranged in the server or the terminal.

Next, another exemplary embodiment of the present invention will be described.

An image comparison device according to this exemplary embodiment includes an image acquisition unit which acquires an image which is the comparison object, an image display unit which displays the image acquired by the image acquisition unit, an input location pattern acquisition unit which acquires an input location pattern representing a general location of the area which is the comparison object in the area of the image displayed in the image display unit, a comparison object general area estimation unit which estimates a comparison object general area representing a general area which is the comparison object in the image displayed in the image display unit on the basis of the input location pattern, an image comparison unit which acquires information representing the image in the comparison object general area as at least one of a search image and a registered image and derives an integrated comparison result on the basis of comparison results for individual local areas with respect to the search image and the registered image, and a comparison result presentation unit which presents the integrated comparison result.

An image comparison system according to this exemplary embodiment includes a terminal and a server, wherein the terminal includes an image acquisition unit which acquires an image which is the comparison object, an image display unit which displays the image acquired by the image acquisition unit, an input location pattern acquisition unit which acquires an input location pattern representing a general location of the area which is the comparison object in the area of the image displayed in the image display unit, a comparison object general area estimation unit which estimates a comparison object general area representing a general area which is the comparison object in the image displayed in the image display unit on the basis of the input location pattern, a comparison object general area image information transmission unit which transmits the information representing the image in the comparison object general area to the server, and a comparison result presentation unit which receives the integrated comparison result with respect to the image which is the comparison object from the server and presents the integrated comparison result, and the server includes a comparison object general area image information reception unit which receives the information representing the image in the comparison object general area from the terminal, an image comparison unit which acquires the information representing the image in the comparison object general area that is received by the comparison object general area image information reception unit as at least one of a search image and a registered image and derives the integrated comparison result on the basis of comparison results for individual local areas with respect to the search image and the registered image, and a comparison result transmission unit which transmits the integrated comparison result to the terminal.

A terminal according to this exemplary embodiment, which communicates with a server which derives an integrated comparison result on the basis of comparison results for individual local areas with respect to the image which is the comparison object, includes an image acquisition unit which acquires an image which is the comparison object, an image display unit which displays the image acquired by the image acquisition unit, an input location pattern acquisition unit which acquires an input location pattern representing a general location of the area which is the comparison object in the area of the image displayed in the image display unit, a comparison object general area estimation unit which estimates a comparison object general area representing a general area which is the comparison object in the image displayed in the image display unit on the basis of the input location pattern, a comparison object general area image information transmission unit which transmits information representing the image in the comparison object general area to the server, and a comparison result presentation unit which receives the integrated comparison result with respect to the image which is the comparison object from the server and presents the integrated comparison.

A server according to this exemplary embodiment, which communicates with a terminal which estimates a comparison object general area representing a general area which is a comparison object in an image which is the comparison object, includes a comparison object general area image information reception unit which receives the information representing the image in the comparison object general area from the terminal, an image comparison unit which acquires the information representing the image in the comparison object general area that is received by the comparison object general area image information reception unit as at least one of a search image and a registered image and derives an integrated comparison result on the basis of comparison results for individual local areas with respect to the search image and the registered image, and a comparison result transmission unit which transmits the integrated comparison result to the terminal.

An image comparison method according to this exemplary embodiment includes: acquiring an image which is a comparison object, displaying the image in an image display unit, acquiring an input location pattern representing a general location of the area which is the comparison object in the area of the image displayed in the image display unit, estimating a comparison object general area representing a general area which is the comparison object in the image displayed in the image display unit on the basis of the input location pattern, acquiring information representing the image in the comparison object general area as at least one of a search image and a registered image, deriving an integrated comparison result on the basis of comparison results for individual local areas with respect to the search image and the registered image, and presenting the integrated comparison result.

A terminal control method according to this exemplary embodiment includes: acquiring an image which is a comparison object, displaying the image in an image display unit, acquiring an input location pattern representing a general location of the area which is the comparison object in the area of the image displayed in the image display unit, estimating a comparison object general area representing a general area which is the comparison object in the image displayed in the image display unit on the basis of the input location pattern, transmitting information representing the image in the comparison object general area to a server which derives an integrated comparison result on the basis of comparison results for individual local areas with respect to the image which is the comparison object, and receiving the integrated comparison result with respect to the image which is the comparison object from the server.

A non-transitory computer-readable medium according to the exemplary embodiment stores a terminal control program which causes a computer, which is provided in a terminal communicating with a server which derives an integrated comparison result on the basis of comparison results for individual local areas with respect to an image which is a comparison object, to function as: image acquisition means for acquiring an image which is the comparison object, image display means for displaying the image acquired by the image acquisition means, input location pattern acquisition means for acquiring an input location pattern representing a general location of the area which is the comparison object in the area of the image displayed in the image display means, comparison object general area estimation means for estimating a comparison object general area representing a general area which is the comparison object in the image displayed in the image display means on the basis of the input location pattern, comparison object general area image information transmission means for transmitting information representing the image in the comparison object general area to the server, and comparison result presentation means for receiving the integrated comparison result with respect to the image which is the comparison object from the server and presenting the integrated comparison result.

In each exemplary embodiment of the present invention mentioned above, a computer program, which causes the CPU of each device to perform the operation of the image comparison device, the server, or the terminal described with reference with each flowchart, may be stored in a storage device (storage medium) of each device. The CPU of each device may read the stored computer program and execute the computer program. In this case, the present invention is composed using a code of the computer program or the storage medium.

Further, in each exemplary embodiment of the present invention mentioned above, a part of or the whole of the function of each functional block may be composed using a hardware circuit.

Further, in each exemplary embodiment of the present invention mentioned above, a configuration, in which a part of or the whole of the function of each functional block may be realized by a processor such as a GPU (Graphics Processing Unit) or the like executing the computer program, may be used.

Each exemplary embodiment mentioned above can be appropriately combined and carried out.

The present invention is not limited to each exemplary embodiment mentioned above and the present invention can be realized in various aspects.

A part of or the whole of the above-mentioned exemplary embodiment can be described as the supplementary notes described below. However, the present invention is not limited to the supplementary notes described below.

(Supplementary Note 1)

An image comparison device comprising:

image acquisition means for acquiring an image which is a comparison object;

image display means for displaying the image acquired by the image acquisition means;

input location pattern acquisition means for acquiring an input location pattern representing a general location of the area which is the comparison object in the area of the image displayed in the image display means;

comparison object general area estimation means for estimating a comparison object general area representing a general area which is the comparison object in the image displayed in the image display means on the basis of the input location pattern;

image comparison means for acquiring information representing the image in the comparison object general area as at least one of a search image and a registered image and deriving an integrated comparison result on the basis of comparison results for individual local areas with respect to the search image and the registered image; and

comparison result presentation means for presenting the integrated comparison result.

(Supplementary Note 2)

The image comparison device described in supplementary note 1 characterized in further comprising:

image storage means which store information representing the registered image, wherein

the image comparison means specify the registered image corresponding to the search image among the registered images on the basis of the integrated comparison result with respect to the search image and the each registered image, and

the comparison result presentation means present the information with respect to the registered image corresponding to the search image.

(Supplementary Note 3)

The image comparison device described in supplementary note 1 or supplementary note 2 characterized in that

the image display means are composed using a device which detects a contact location at which a user contacts with a display area during a touch operation, and

the input location pattern acquisition means acquire a contact pattern representing a pattern of the contact location as the input location pattern.

(Supplementary Note 4)

The image comparison device described in any one of supplementary notes 1 to 3 characterized in that

the input location pattern acquisition means acquire information representing locations of two points as the input location pattern, and

the comparison object general area estimation means estimate that an area inside a rectangle whose diagonal is a line connecting the two points is the comparison object general area.

(Supplementary Note 5)

The image comparison device described in any one of supplementary notes 1 to 4 characterized in that

the input location pattern acquisition means acquire information representing a location of one point as the input location pattern, and

the comparison object general area estimation means estimate that an area inside a rectangle having four vertexes, whose distances from the one point are respectively predetermined, is the comparison object general area.

(Supplementary Note 6)

The image comparison device described in any one of supplementary notes 1 to 5 characterized in that

the input location pattern acquisition means acquire information representing locations of three points as the input location pattern, and

the comparison object general area estimation means estimate that an area inside a parallelogram whose vertexes include the three points is the comparison object general area.

(Supplementary Note 7)

The image comparison device described in any one of supplementary notes 1 to 5 characterized in that

the input location pattern acquisition means acquire information representing locations of three points as the input location pattern, and

the comparison object general area estimation means estimate that an area inside a circumscribed rectangle of a parallelogram whose vertexes include the three points is the comparison object general area.

(Supplementary Note 8)

The image comparison device described in any one of supplementary notes 1 to 7 characterized in that

the input location pattern acquisition means acquire information representing locations of n points (where n is an integer of three or more) as the input location pattern, and

the comparison object general area estimation means estimate that an area inside a polygon whose n vertexes are the n points is the comparison object general area.

(Supplementary Note 9)

The image comparison device described in any one of supplementary notes 1 to 7 characterized in that

the input location pattern acquisition means acquire information representing locations of n points (where n is an integer of three or more) as the input location pattern, and

the comparison object general area estimation means estimate that an area inside a circumscribed rectangle of a polygon whose n vertexes are the n points is the comparison object general area.

(Supplementary Note 10)

The image comparison device described in any one of supplementary notes 1 to 9 characterized in that

the input location pattern acquisition means acquire information representing a curved line as the input location pattern, and

the comparison object general area estimation means estimate that an area surrounded by the curved line and another curved line that is derived by rotating the curved line around the middle point between the start point and the end point of the curved line by a predetermined angle is the comparison object general area.

(Supplementary Note 11)

The image comparison device described in any one of supplementary notes 1 to 9 characterized in that

the input location pattern acquisition means acquire information representing a curved line as the input location pattern, and

the comparison object general area estimation means estimate that an area inside a circumscribed rectangle of an area which is surrounded by the curved line and another curved line derived by rotating the curved line around the middle point between the start point and the end point of the curved line by a predetermined angle is the comparison object general area.

(Supplementary Note 12)

The image comparison device described in any one of supplementary notes 1 to 11 characterized in that

the input location pattern acquisition means acquire information representing a curved line as the input location pattern, and

the comparison object general area estimation means estimate that an area surrounded by the curved line and another curved line which is line-symmetric to the curved line with respect to the line connecting the start point and the end point of the curved line is the comparison object general area.

(Supplementary Note 13)

The image comparison device described in any one of supplementary notes 1 to 11 characterized in that

the input location pattern acquisition means acquire information representing a curved line as the input location pattern, and

the comparison object general area estimation means estimate that an area inside a circumscribed rectangle of the area which is surrounded by the curved line and another curved line which is line-symmetric to the curved line with respect to the line connecting the start point and the end point of the curved line is the comparison object general area.

(Supplementary Note 14)

The image comparison device described in any one of supplementary notes 1 to 13 characterized in that

the input location pattern acquisition means acquire information representing a line which makes a closed area as the input location pattern, and

the comparison object general area estimation means estimate that the closed area is the comparison object general area.

(Supplementary Note 15)

The image comparison device described in any one of supplementary notes 1 to 13 characterized in that

the input location pattern acquisition means acquire information representing a line which makes a closed area as the input location pattern, and

the comparison object general area estimation means estimate that an area inside a circumscribed rectangle of the closed area is the comparison object general area.

(Supplementary Note 16)

The image comparison device described in any one of supplementary notes 1 to 15 characterized in that

the input location pattern acquisition means acquire information representing a curved line as the input location pattern, and

the comparison object general area estimation means take the curved line as connected two lines and estimates that an area inside a parallelogram whose two sides are the two lines is the comparison object general area.

(Supplementary Note 17)

The image comparison device described in any one of supplementary notes 1 to 15 characterized in that

the input location pattern acquisition means acquire information representing a curved line as the input location pattern, and

the comparison object general area estimation means take the curved line as connected two lines and estimate that an area inside a circumscribed rectangle of a parallelogram whose two sides are the two lines is the comparison object general area.

(Supplementary Note 18)

The image comparison device described in any one of supplementary notes 1 to 17 characterized further comprising:

input location pattern shape discrimination means for discriminating a shape of the input location pattern, wherein

the comparison object general area estimation means estimate the comparison object general area on the basis of the shape discriminated by the input location pattern shape discrimination means.

(Supplementary Note 19)

The image comparison device described in any one of supplementary notes 1 to 18 characterized in that

the image display means display the comparison object general area estimated from the displayed image superimposing on the image,

the input location pattern acquisition means further acquire a correction location pattern for correcting the comparison object general area displayed in the image display means, and

the image comparison device further comprises comparison object general area correction means for correcting the comparison object general area on the basis of the correction location pattern.

(Supplementary Note 20)

The image comparison device described in any one of supplementary notes 2 to 19 characterized in that

the image storage means store related information, which is related to the registered image, associating with the registered image, and

the comparison result presentation means acquire the related information which is related to the registered image specified by the image comparison means, and present the acquired related information.

(Supplementary Note 21)

The image comparison device described in supplementary note 20 characterized in that

the image acquisition means acquire the search image together with the related information of the search image, and

the image comparison means specify the registered image corresponding to the search image among the registered images whose related information is related to the related information on the search image and which are stored in the image storage means.

(Supplementary Note 22)

The image comparison device described in supplementary note 21 characterized in that

the related information includes position information representing positions of places related to the stored images, and

the image comparison means specify the registered image corresponding to the search image among the registered images, whose distances from positions represented by the position information included in the related information of the registered images to a position represented by the position information included in the related information of the search image are less than or equal to a threshold value and which are stored in the image storage means.

(Supplementary Note 23)

The image comparison device described in supplementary note 21 or supplementary note 22 characterized in that

the related information includes direction information representing directions related to the stored images, and

the image comparison means specify the registered image corresponding to the search image among the registered images whose differences from the directions represented by the direction information included in the related information of the registered images to an direction represented by the direction information included in the related information of the search image are less than or equal to a threshold value and which are stored in the image storage means.

(Supplementary Note 24)

The image comparison device described in any one of supplementary notes 1 to 23 characterized in that

the image comparison means acquire the image feature value of the image in the comparison object general area as the information representing the image in the comparison object general area and derive the integrated comparison result using the acquired image feature value.

(Supplementary Note 25)

The image comparison device described in any one of supplementary notes 2 to 24 characterized in that

the image storage means store the image feature value of the registered image as the information representing the registered image.

(Supplementary Note 26)

An image comparison system comprising a terminal and a server, wherein

the terminal includes:

image acquisition means for acquiring an image which is a comparison object;

image display means for displaying the image acquired by the image acquisition means;

input location pattern acquisition means for acquiring an input location pattern representing a general location of an area which is the comparison object in the area of the image displayed in the image display means;

comparison object general area estimation means for estimating a comparison object general area representing a general area which is the comparison object in the image displayed in the image display means on the basis of the input location pattern;

comparison object general area image information transmission means for transmitting information representing the image in the comparison object general area to the server; and

comparison result presentation means for receiving an integrated comparison result with respect to the image which is the comparison object from the server and presenting the integrated comparison result, and

the server includes:

comparison object general area image information reception means for receiving the information representing the image in the comparison object general area from the terminal;

image comparison means for acquiring the information representing the image in the comparison object general area, which is received by the comparison object general area image information reception means as at least one of a search image and a registered image, and deriving the integrated comparison result on the basis of comparison results for individual local areas with respect to the search image and the registered image; and

comparison result transmission means for transmitting the integrated comparison result to the terminal.

(Supplementary Note 27)

The image comparison system described in supplementary note 26 characterized in that

the server further includes:

image storage means for storing information representing the registered image, wherein

the image comparison means specify the registered image corresponding to the search image among the registered images on the basis of the integrated comparison result with respect to the search image and the each registered image,

the comparison result transmission means transmit information representing the registered image corresponding to the search image to the terminal, and

the comparison result presentation means of the terminal present information with respect to the registered image corresponding to the search image.

(Supplementary Note 28)

The image comparison system described in supplementary note 26 or supplementary note 27 characterized in that

the comparison object general area image information transmission means of the terminal transmit an image feature value of the image in the comparison object general area to the server as the information representing the image in the comparison object general area.

(Supplementary Note 29)

A terminal comprising:

image acquisition means for acquiring an image which is a comparison object;

image display means for displaying the image acquired by the image acquisition means;

input location pattern acquisition means for acquiring an input location pattern representing a general location of the area which is the comparison object in the area of the image displayed in the image display means;

comparison object general area estimation means for estimating a comparison object general area representing a general area which is the comparison object in the image displayed in the image display means on the basis of the input location pattern;

comparison object general area image information transmission means for transmitting information representing the image in the comparison object general area to a server which derives an integrated comparison result on the basis of comparison results for individual local areas with respect to an image which is the comparison object; and

comparison result presentation means for receiving the integrated comparison result with respect to the image which is the comparison object from the server, and presenting the integrated comparison result.

(Supplementary Note 30)

The terminal described in supplementary note 29 characterized in that

the image display means are composed using a device which detects a contact location at which a user contacts with the display area during touch operation, and

the input location pattern acquisition means acquire a contact pattern representing a pattern of the contact location as the input location pattern.

(Supplementary Note 31)

The terminal described in supplementary note 29 or supplementary note 30 characterized in that

the comparison object general area image information transmission means transmit an image feature value of the image in the comparison object general area to the server as the information representing the image in the comparison object general area.

(Supplementary Note 32)

A server which communicates with a terminal, which estimates a comparison object general area representing a general area which is a comparison object in an image which is the comparison object, comprising:

comparison object general area image information reception means for receiving information representing the image in the comparison object general area from the terminal;

image comparison means for acquiring the information representing the image in the comparison object general area that is received by the comparison object general area image information reception means as at least one of a search image and a registered image, and deriving an integrated comparison result on the basis of comparison results for individual local areas with respect to the search image and the registered image; and

comparison result transmission means for transmitting the integrated comparison result to the terminal.

(Supplementary Note 33)

The server described in supplementary note 32 characterized in further comprising:

image storage means for storing information representing the registered image, wherein

the image comparison means specify the registered image corresponding to the search image among the registered images on the basis of the integrated comparison result with respect to the search image and the each registered image.

(Supplementary Note 34)

The server described in supplementary note 32 or supplementary note 33 characterized in that

the comparison object general area image information reception means receive an image feature value of the image in the comparison object general area from the terminal as the information representing the image in the comparison object general area.

(Supplementary Note 35)

An image comparison method comprising:

acquiring an image which is a comparison object;

displaying the image in image display means,

acquiring an input location pattern representing a general location of the area which is the comparison object in an area of the image displayed in the image display means;

estimating a comparison object general area representing a general area which is the comparison object in the image displayed in the image display means on the basis of the input location pattern;

acquiring information representing the image in the comparison object general area as at least one of a search image and a registered image, and deriving an integrated comparison result on the basis of comparison results for individual local areas with respect to the search image and the registered image; and

presenting the integrated comparison result.

(Supplementary Note 36)

The image comparison method described in supplementary note 35 characterized by

storing information representing the registered image in image storage means,

specifying the registered image corresponding to the search image on the basis of the integrated comparison result of the search image and the each registered image, and

presenting the information representing the registered image corresponding to the search image.

(Supplementary Note 37)

An image comparison method using a terminal and a server, wherein

the terminal

acquires an image which is a comparison object,

displays the acquired image in image display means,

acquires an input location pattern representing a general location of an area which is the comparison object in an area of the image displayed in the image display means,

estimates a comparison object general area representing a general area which is the comparison object in the image displayed in the image display means on the basis of the input location pattern, and

transmits information representing the image in the comparison object general area to the server, and

the server

receives the information representing the image in the comparison object general area from the terminal,

acquires information representing the image in the comparison object general area that is received as at least one of a search image and a registered image,

derives an integrated comparison result on the basis of comparison results for individual local areas with respect to the search image and the registered image, and

transmits the integrated comparison result to the terminal, and

the terminal

receives the integrated comparison result from the server and presents the integrated comparison result.

(Supplementary Note 38)

The image comparison method described in supplementary note 37 characterized in that

the server

stores information representing the registered image in image storage means,

specifies the registered image corresponding to the search image among the registered images on the basis of the integrated comparison result with respect to the search image and the each registered image, and

transmits information representing the registered image corresponding to the search image to the terminal as the integrated comparison result, and

the terminal

presents the information representing the registered image corresponding to the search image as the integrated comparison result.

(Supplementary Note 39)

A terminal control method comprising:

acquiring an image which is a comparison object;

displaying the image in image display means;

acquiring an input location pattern representing a general location of an area which is the comparison object in an area of the image displayed in the image display means;

estimating a comparison object general area representing a general area which is the comparison object in the image displayed in the image display means on the basis of the input location pattern;

transmitting information representing the image in the comparison object general area to a server which derives an integrated comparison result on the basis of comparison results for individual local areas with respect to an image which is the comparison object; and

receiving the integrated comparison result with respect to the image which is the comparison object from the server.

(Supplementary Note 40)

A server control method comprising:

receiving information representing an image in a comparison object general area from a terminal which estimates the comparison object general area representing a general area which is a comparison object in an image which is the comparison object;

acquiring information representing the image in the comparison object general area that is received as at least one of a search image and a registered image, and deriving an integrated comparison result on the basis of comparison results for individual local areas with respect to the search image and the registered image; and

transmitting the integrated comparison result to the terminal.

(Supplementary Note 41)

A non-transitory computer-readable medium storing an image comparison program which causes a computer to function as:

image acquisition means for acquiring an image which is a comparison object;

image display means for displaying the image;

input location pattern acquisition means for acquiring an input location pattern representing a general location of an area which is the comparison object in an area of the image displayed in the image display means;

comparison object general area estimation means for estimating a comparison object general area representing a general area which is the comparison object in the image displayed in the image display means on the basis of the input location pattern;

image comparison means for acquiring information representing the image in the comparison object general area as at least one of a search image and a registered image, and deriving an integrated comparison result on the basis of comparison results for individual local areas with respect to the search image and the registered image; and

comparison result presentation means for presenting the integrated comparison result.

(Supplementary Note 42)

The non-transitory computer-readable medium described in supplementary note 41 characterized in storing the image comparison program which further causes a computer function as:

image storage means for storing information representing the registered image, wherein

the image comparison means specify the registered image corresponding to the search image on the basis of the integrated comparison result of the search image and the each registered image, and

the comparison result presentation means present information representing the registered image corresponding to the search image as the integrated comparison result.

(Supplementary Note 43)

A non-transitory computer-readable medium storing a terminal control program which causes a computer, which is provided in a terminal that communicates with a server which derives an integrated comparison result on the basis of comparison results for individual local areas with respect to an image which is a comparison object, to function as:

image acquisition means for acquiring the image which is the comparison object;

image display means for displaying the image acquired by the image acquisition means;

input location pattern acquisition means for acquiring an input location pattern representing a general location of an area which is the comparison object in an area of the image displayed in the image display means;

comparison object general area estimation means for estimating a comparison object general area representing a general area which is the comparison object in the image displayed in the image display means on the basis of the input location pattern;

comparison object general area image information transmission means for transmitting information representing the image in the comparison object general area to the server; and

comparison result presentation means for receiving the integrated comparison result with respect to the image which is the comparison object from the server, and presenting the integrated comparison result.

(Supplementary Note 44)

The non-transitory computer-readable medium described in supplementary note 43 characterized in storing the terminal control program wherein

the image display means detect a contact location at which a user contacts with a display area during touch operation, and

the input location pattern acquisition means acquire a contact pattern representing a pattern of the contact location as the input location pattern.

(Supplementary Note 45)

A non-transitory computer-readable medium storing a server control program which causes a computer, which is provided in a server that communicates with a terminal which estimates a comparison object general area representing a general area which is a comparison object in an image which is the comparison object, to function as:

comparison object general area image information reception means for receiving information representing the image in the comparison object general area from the terminal;

image comparison means for acquiring the information representing the image in the comparison object general area that is received by the comparison object general area image information reception means as at least one of a search image and a registered image, and deriving an integrated comparison result on the basis of comparison results for individual local areas with respect to the search image and the registered image; and

comparison result transmission means for transmitting the integrated comparison result to the terminal.

(Supplementary Note 46)

The non-transitory computer-readable medium described in supplementary note 45 characterized in storing the server control program which further causes a computer to function as:

image storage means for storing information representing the registered image, wherein

the image comparison means specify the registered image corresponding to the search image among the registered images on the basis of the integrated comparison result of the search image and the each registered image.

The present invention has been described above with reference to the exemplary embodiment. However, the present invention is not limited to the above-mentioned exemplary embodiment. Various changes in the configuration or details of the invention of the present application that can be understood by those skilled in the art can be made without departing from the scope of the invention.

This application claims priority from Japanese Patent Application No. 2010-237463 filed on Oct. 22, 2010, the disclosure of which is hereby incorporated by reference in its entirety.

### INDUSTRIAL APPLICABILITY

The present invention can provide an image comparison device of which comparison accuracy and processing speed when deriving an integrated comparison result using comparison results for individual local areas are improved. The present invention can be applied to, for example, a system which searches for a registered image having a high degree of consistency with an area of a guide plate or the like which is included in a search image as a part, and provides, to the user, information such as a caption, an indication in other languages, or the like of the registered image that is searched for. Further, the present invention can be applied to a system which presents the information in augmented reality by superimposing information related to the registered image that is searched for on the search image. Further, the guide plate or the like may be not only a general guide plate installed inside or outside a building but also an outer wall of a building, a direction board installed inside or outside a building, papers and documents, a poster, a memo pad, a memorandum written on a sticky, an advertising leaflet, a menu of a restaurant, or the like.

### DESCRIPTION OF SYMBOL

1, 2, 3, 4, and 5 image comparison device
6 image comparison system
61 terminal
62 server
101 image acquisition unit
102, 202, and 502 image display unit
103 input location pattern acquisition unit
104, 304, and 404 comparison object general area estimation unit
105, 205, and 605 image comparison unit
106, 206, and 606 comparison result presentation unit
203, 303, and 503 contact pattern acquisition unit
207 image storage unit
303 contact pattern acquisition unit
408 contact pattern shape discrimination unit
509 comparison object general area correction unit
611 comparison object general area image information transmission unit
621 comparison object general area image information reception unit
622 comparison result transmission unit
1001 control unit
1002 storage device
1003 input device
1004 display device
1005 imaging device
2003 display device with coordinates input function

What is claimed is:

1. An image comparison device comprising:
an image acquisition unit which acquires an image;
an image display unit which displays the image acquired by the image acquisition unit;
an input location pattern acquisition unit which acquires an input location pattern representing a general location of an area which is a comparison object in an area of the image displayed by the image display unit;
a comparison object general area estimation unit which estimates, on the basis of the input location pattern, a comparison object general area which is a general area of the comparison object in the image displayed by the image display unit; and
a comparison result presentation unit which presents a result of comparison between a search image and a registered image, at least one of which is an image in the comparison object general area.

2. The image comparison device according to claim 1 comprising:
an image comparison unit which derives the result of the comparison by comparing the search image with the registered image.

3. The image comparison device according to claim 2 comprising:
an image storage unit which stores information representing one or more of the registered images, wherein
the image comparison unit specifies a registered image corresponding to the search image among the registered images from the comparison result between the search image and each of the registered images, and
the comparison result presentation unit presents information on the registered image corresponding to the search image.

4. The image comparison device according to claim 1 wherein
the image display unit displays the comparison object general area, which is estimated in the displayed image, superimposed on the displayed image,
the input location pattern acquisition unit further acquires a correction location pattern for correcting the comparison object general area, and
the image comparison device further comprises a comparison object general area correction unit which corrects the comparison object general area on the basis of the correction location pattern.

5. The image comparison device according to claim 2 wherein
the image comparison unit acquires an image feature value of the search image and an image feature value of the registered image and derives the comparison result using each of the acquired image feature values.

6. An image comparison system comprising:
a server and the image comparison device according to claim 1, wherein
the image comparison device includes:
a comparison object general area image information transmission unit which transmits information, which represents an image in the comparison object general area, to the server, wherein
the comparison result presentation unit present the comparison result received from the server, and
the server includes:
a comparison object general area image information reception unit which receives information, which represents an image in the comparison object general area, from the image comparison device;
an image comparison unit which performs a comparison between the search image and the registered image, at least one of which is an image in the comparison object general area, and derives the comparison result; and
a comparison result transmission unit which transmits the comparison result to the image comparison device.

7. An image comparison method comprising:
acquiring an image;
displaying the acquired image on an image display unit;
acquiring an input location pattern representing a general location of an area which is a comparison object in an area of the image displayed on the image display unit;
estimating, on the basis of the input location pattern, a comparison object general area which is a general area of the comparison object in the image displayed on the image display unit; and
presenting a comparison result between a search image and a registered image, at least one of which is an image in the comparison object general area.

8. A non-transitory computer-readable medium storing an image comparison program which makes a computer function as:
an image acquisition unit which acquires an image,
an image display unit which displays the image acquired by the image acquisition unit,
an input location pattern acquisition unit which acquires an input location pattern representing a general location of an area which is a comparison object in an area of the image displayed by the image display unit,
a comparison object general area estimation unit which estimates, on the basis of the input location pattern, a comparison object general area which is a general area of the comparison object in the image displayed by the image display unit, and
a comparison result presentation unit which presents a comparison result between a search image and a registered image, at least one of which is the image in the comparison object general area.

9. The non-transitory computer-readable medium according to claim 8 storing the image comparison program which makes a computer function as:
an image comparison unit which derives the result of the comparison by performing a comparison between the search image and the registered image.

10. The non-transitory computer-readable medium according to claim 9 storing the image comparison program which makes a computer function as:
an image storage unit which stores information representing one or more of the registered images,
the image comparison unit which specifies the registered image corresponding to the search image among the registered images on the basis of a comparison result between the search image and each of the registered images, and
the comparison result presentation unit which presents information on the registered image corresponding to the search image.
